(19) United States
(12) Patent Application Publication
(10) Pub. No.: US 2024/0297561 A1
(43) Pub. Date: Sep. 5, 2024

(54) METHOD FOR OPERATING A LINEAR DRIVE SYSTEM AND LINEAR DRIVE SYSTEM

(71) Applicant: Beckhoff Automation GmbH, Verl (DE)

(72) Inventors: Changsheng Hua, Verl (DE); Christian Ott, Lauda-Königshofen (DE); Dietmar Hamberger, Marktheidenfeld (DE)

(21) Appl. No.: 18/661,164

(22) Filed: May 10, 2024

Related U.S. Application Data
(63) Continuation of application No. PCT/EP2022/082113, filed on Nov. 16, 2022.

(30) Foreign Application Priority Data
Nov. 19, 2021 (DE) 10 2021 130 313.3

(51) Int. Cl. H02K 41/03; B65G 54/02

(52) U.S. Cl. CPC H02K 41/031; B65G 54/02

(57) ABSTRACT

A method is provided for operating a linear drive system having primary and secondary parts. The primary part includes an energizable electromagnet device. The secondary part includes a magnet arrangement. A magnetic interaction between the electromagnet device and the magnet arrangement can be caused to move the primary and secondary parts relative to one other. The primary part has a sensor device for detecting a magnetic field generated by the magnet arrangement. In an initial measurement, the magnetic field is detected at different positions of the primary part, and position-dependent reference magnetic field data are provided. A position determination is carried out, in that the magnetic field is detected at a current position of the primary part and current magnetic field data are provided, and, based on the reference magnetic field data and the current magnetic field data, the current position of the primary part is determined.

### CROSS REFERENCE TO RELATED APPLICATIONS

This patent application is a continuation of International Patent Application No. PCT/EP2022/082113, “Method for Operating a Linear Drive System, and Linear Drive System,” filed 16 Nov. 2022, which claims the priority of German patent application DE 10 2021 130 313.3, “Verfahren zum Betreiben eines linearen Antriebssystems und lineares Antriebssystem,” filed 19 Nov. 2021, each of which is incorporated by reference herein, in the entirety and for all purposes.

### FIELD

The present invention relates to a method for operating a linear drive system. The drive system comprises a primary part and a secondary part, which may be moved in a translatory manner relative to each other. In the method, a position determination is carried out for the primary part. The invention further relates to a linear drive system.

### BACKGROUND

A linear drive system allows for generating a linear translatory movement. Such a system may be used in different areas, for example in order to generate a translatory movement of a machine element or of a system component. The movement generation may be based on a magnetic or electromagnetic principle.

In this context, the drive system, which may also be referred to as a linear motor, may comprise a primary part and a secondary part. The primary part and the secondary part may be moved in a translatory manner relative to each other. For example, the secondary part may be stationary and the primary part may be movable relative to the secondary part. The primary part may comprise an electromagnet device that may be energized, and the secondary part may comprise a magnet arrangement of permanent magnets arranged next to each other. By energizing the electromagnet device of the primary part, a magnetic interaction between the electromagnet device and the magnet arrangement, and thereby a movement of the primary part and the secondary part relative to each other, may be caused.

In order to reliably control the movement, it is usually intended to determine a position of the primary part in relation to the secondary part. For this purpose, in addition to the primary part and secondary part used for the drive, a corresponding measuring device may be used. Examples include a magneto-strictive linear measuring system, and an optical, inductive or magnetic linear scale. This requires the use of additional attachments, and is associated with a corresponding space requirement.

### SUMMARY

The present invention provides an improved method for operating a linear drive system and an improved linear drive system.

According to a first aspect, a method for operating a linear drive system is proposed. The linear drive system comprises a primary part and a secondary part, which may be moved in a translatory manner relative to each other. The primary part comprises an electromagnet device which may be energized. The secondary part comprises a magnet arrangement of permanent magnets arranged next to each other. By energizing the electromagnet device of the primary part, a magnetic interaction between the electromagnet device and the magnet arrangement of the secondary part may be caused to move the primary part and the secondary part relative to each other.

The primary part comprises a sensor device of magnetic field sensors for detecting a magnetic field generated by the magnet arrangement of the secondary part. In an initial measurement, the magnetic field of the magnet arrangement of the secondary part is detected with the aid of the sensor device at different positions of the primary part with respect to the secondary part and position-dependent reference magnetic field data are provided. A position determination for the primary part is carried out, in that the magnetic field of the magnet arrangement of the secondary part is detected with the aid of the sensor device at a current position of the primary part with respect to the secondary part and current magnetic field data are provided, and based on the reference magnetic field data and the current magnetic field data, the current position of the primary part with respect to the secondary part is determined.

According to a second aspect, a linear drive system is proposed. The linear drive system comprises a primary part and a secondary part which may be moved in a translatory manner relative to each other. The primary part comprises an energizable electromagnet device. The secondary part comprises a magnet arrangement of permanent magnets arranged next to each other. By energizing the electromagnet device of the primary part, a magnetic interaction between the electromagnet device and the magnet arrangement of the secondary part may be caused to move the primary part and the secondary part relative to each other.

The primary part comprises a sensor device of magnetic field sensors for detecting a magnetic field generated by the magnet arrangement of the secondary part. The linear drive system is embodied, in an initial measurement, to detect the magnetic field of the magnet arrangement of the secondary part with the aid of the sensor device at different positions of the primary part with respect to the secondary part and to provide position-dependent reference magnetic field data. The linear drive system is embodied to carry out a position determination for the primary part, in that the magnetic field of the magnet arrangement of the secondary part is detected with the aid of the sensor device at a current position of the primary part with respect to the secondary part and current magnetic field data are provided, and based on the reference magnetic field data and the current magnetic field data, the current position of the primary part with respect to the secondary part is determined.

According to a third aspect, a method for operating a linear drive system is proposed. The linear drive system comprises a primary part and a secondary part, which may be moved in a translatory manner relative to each other. The primary part comprises an electromagnet device which may be energized. The secondary part comprises a magnet arrangement of permanent magnets arranged next to each other. By energizing the electromagnet device of the primary part, a magnetic interaction between the electromagnet device and the magnet arrangement of the secondary part may be caused to move the primary part and the secondary part relative to each other.

The primary part comprises a sensor device of magnetic field sensors for detecting a magnetic field generated by the magnet arrangement of the secondary part. In an initial measurement, the magnetic field of the magnet arrangement of the secondary part is detected with the aid of the sensor device at different positions of the primary part with respect to the secondary part and position-dependent reference magnetic field data are provided. A position determination for the primary part is carried out, in that the magnetic field of the magnet arrangement of the secondary part is detected with the aid of the sensor device at a current position of the primary part with respect to the secondary part and current magnetic field data are provided, and based on the reference magnetic field data and the current magnetic field data, the current position of the primary part with respect to the secondary part is determined.

The position determination comprises carrying out a comparison of at least a part of the current magnetic field data with parts of the reference magnetic field data. The position determination is based on dividing up the permanent magnets of the magnet arrangement of the secondary part into a plurality of magnet groups of permanent magnets arranged next to each other. The reference magnetic field data comprises a plurality of magnetic field patterns, each of which being associated with a magnet group of permanent magnets arranged next to each other of the magnet arrangement of the secondary part.

### EXAMPLES

The examples described in the following relate to an improved method for operating a linear drive system. Further described is a correspondingly embodied linear drive system.

This object is solved by the features of the independent claims. Further advantageous embodiments of the invention are indicated in the dependent claims.

A method for operating a linear drive system is proposed. The linear drive system comprises a primary part and a secondary part which may be moved in a translatory manner relative to each other. The primary part comprises an electromagnet device which may be energized, and the secondary part comprises a magnet arrangement having permanent magnets arranged next to each other. By energizing the electromagnet device of the primary part, a magnetic interaction between the electromagnet device and the magnet arrangement of the secondary part may be caused to move the primary part and the secondary part relative to each other.

The primary part comprises a sensor device comprising magnetic field sensors for detecting a magnetic field generated by the magnet arrangement of the secondary part. In an initial measurement, the magnetic field of the magnet arrangement of the secondary part is detected at different positions of the primary part with respect to the secondary part with the aid of the sensor device and position-dependent reference magnetic field data are provided. Furthermore, a position determination is carried out for the primary part. For this purpose, the magnetic field of the magnet arrangement of the secondary part is detected at a current position of the primary part with respect to the secondary part with the aid of the sensor device and current magnetic field data are provided. Based on the reference magnetic field data and the current magnetic field data, the current position of the primary part with respect to the secondary part is determined.

With the aid of the proposed method, a reliable and accurate position determination for the primary part of the linear drive system may be achieved. The secondary part of the drive system already used for the movement drive is used for position determination, together with the sensor device of magnetic field sensors provided on the primary part. In this way, the position determination may be realized without space-consuming attachments, and thus in a space-saving and cost-effective manner.

The method makes use of the fact that the magnetic field, which may be generated by the permanent magnet arrangement of the secondary part and may be detected with the aid of the sensor device of the primary part, may have an essentially periodic course with individual differences along a direction of movement in which the movement of primary part and secondary part may take place relative to each other. Cause of the differences may be tolerances, which the linear drive system and its components may be subject to. These may include mechanical and magnetic angular errors, magnetization errors, density differences, geometric deviations, adhesive gaps, a mechanical offset, etc.

In the initial measurement, the magnetic field of the magnet arrangement of the secondary part is detected at different positions of the primary part in relation to the secondary part with the aid of the sensor device. Position-dependent reference magnetic field data are provided based on this or on the basis of measurement data obtained by detecting the magnetic field. The reference magnetic field data may include and reflect the position-dependent differences of the detected magnetic field of the magnetic arrangement of the secondary part.

In other words, a magnetic fingerprint of one or of a plurality of permanent magnets of the secondary part may be recorded by the initial measurement, respectively. For the actual position determination, which is carried out for an initially still unknown current position of the primary part with respect to the secondary part, the magnetic field of the magnet arrangement of the secondary part is again recorded with the aid of the sensor device of the primary part. Based on this, current magnetic field data are provided. An evaluation based on the reference magnetic field data and the current magnetic field data may therefore be used to determine the current position of the primary part in relation to the secondary part.

The embodiments described above may be used individually or in any combination with one another.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a linear drive system with a primary part and a secondary part, wherein the primary part comprises an electromagnet device and a sensor device having magnetic field sensors for detecting a magnetic field generated by the secondary part, and wherein the secondary part comprises a magnet arrangement of permanent magnets, of which two permanent magnets are combined to form a magnet group;

FIG. 2 is an overhead view of the sensor device of the primary part and the magnet arrangement of the secondary part;

FIG. 3 shows a diagram having courses of a magnetic field strength of a plurality of magnet groups of the magnet arrangement;

FIG. 4 is a depiction of the sensor device and of the magnet arrangement, wherein the sensor device is located in the area of a magnet group and overlaps the magnet group, with an additional depiction of magnetic field patterns of reference magnetic field data assigned to the magnet groups;

FIG. 5 shows a diagram having courses of a magnetic field strength, wherein a zero crossing is shown with reference to the course of a magnetic field component;

FIG. 6 is a diagram showing magnetic field data;

FIG. 7 is a diagram illustrating a position determination by carrying out a similarity procedure using current magnetic field data and reference magnetic field data;

FIG. 8 shows a depiction of the sensor device and of the magnet arrangement, wherein the sensor device is located in the area of two adjacent magnet groups and partially overlaps both magnet groups, with an additional depiction of partial patterns of magnetic field patterns, which are formed according to an overlap of the two magnet groups by the sensor device;

FIG. 9 is a diagram showing current magnetic field data;

FIG. 10 is a diagram showing a partial data set of the current magnetic field data;

FIG. 11 shows a depiction of the sensor device and the magnet arrangement, wherein the sensor device is located in the area of two adjacent magnet groups, with an additional depiction of newly composed magnetic field patterns, which are composed of partial patterns of magnetic field patterns corresponding to an overlap of the two magnet groups by the sensor device;

FIG. 12 is a depiction of the sensor device and the magnet arrangement, wherein the sensor device is located in the area of two adjacent magnet groups, with an additional depiction of a division of the magnetic field sensors of the sensor device into sensor subgroups and, matched to the division, of partial data sets of the current magnetic field data and of partial patterns of magnetic field patterns;

FIGS. 13 and 14 are diagrams showing partial data sets of the current magnetic field data;

FIG. 15 is a depiction of the sensor device and the magnet arrangement, wherein the sensor device is located in the area of two neighboring magnet groups, with an additional depiction of further divisions of the magnetic field sensors of the sensor device to sensor subgroups, as well as partial data sets of the current magnetic field data and partial patterns of magnetic field patterns;

FIG. 16 is a diagram showing a further partial data set of the current magnetic field data;

FIG. 17 shows a depiction of the sensor device and of the magnet arrangement, wherein four permanent magnets are combined into a magnet group and the sensor device is embodied to overlap such a magnet group, with an additional depiction of magnetic field patterns of reference magnetic field data assigned to the magnet groups; and

FIG. 18 is an illustration of the sensor device and the magnet arrangement, with the sensor device offset in the area of a plurality of magnet groups, with an additional illustration of partial patterns of magnetic field patterns and a newly assembled magnetic field pattern.

### DETAILED DESCRIPTION

In the following, further possible details and embodiments are described in more detail, which may be considered for the method and for the linear drive system.

In the linear drive system, the translatory movement of the primary part and secondary part relative to each other may take place along a predetermined direction of movement.

In an embodiment, the linear drive system is embodied in such a way that the secondary part is a stationary component and the primary part is a movable component of the drive system, wherein the primary part may be moved relative to the secondary part due to the magnetic interaction between the electromagnet device of the primary part and the magnet arrangement of the secondary part. An inverse embodiment to this is possible, as well, in which the primary part is a stationary component and the secondary part is a movable component of the drive system, wherein the secondary part may be moved relative to the primary part due to the magnetic interaction between the electromagnet device of the primary part and the magnet arrangement of the secondary part. In both variants, the position of the primary part with respect to the secondary part may be determined by carrying out the method.

At the current position, which is to be determined according to the method, the respective moving component of the linear drive system may (initially still) be at rest. Furthermore, the determination of the current position may be carried out, for example, after a restart or also after a power failure of the linear drive system.

The electromagnet device of the primary part may comprise a plurality of electromagnets that may be energized. The electromagnets may be realized in the form of coils. By suitably energizing the electromagnet device, which may include applying a three-phase current to the electromagnet device, the electromagnet device may be used to generate a varying magnetic field which may interact with the magnetic field generated by the magnet arrangement of the secondary part in such a way as to cause movement of the primary part and secondary part relative to each other.

The magnet arrangement of the secondary part comprises a plurality of permanent magnets arranged next to each other. In this case, adjacent and successive permanent magnets may be arranged opposite to one another with respect to their polarity, with the result that an alternation of polarity exists along the direction of movement of the primary part and secondary part. Along the direction of movement, permanent magnet pairs of permanent magnets with inverse polarities to each other may thus be present.

The permanent magnets of the magnet arrangement may have an elongated shape and be arranged in parallel to one another with respect to their longitudinal axes. The longitudinal axes of the permanent magnets may be oriented substantially perpendicular with regard to the direction of movement. In deviation from an exactly perpendicular orientation, an oblique or slightly oblique orientation of the longitudinal axes of the permanent magnets with respect to the direction of movement may be provided to suppress the occurrence of cogging during movement.

The sensor device of the primary part, which is used to detect the magnetic field of the permanent magnet arrangement of the secondary part, comprises a plurality of magnetic field sensors. In one possible embodiment, the magnetic field sensors are Hall sensors. Alternatively, other sensors such as MR sensors (magneto-resistive sensors) may be used. The magnetic field sensors may be configured to detect the magnetic field or magnetic flux density in different directions, for example in three different directions. The magnetic field sensors may be distributed in one or in a plurality of planes. Furthermore, the magnetic field sensors may be arranged distributed to and spaced apart from one another with respect to the direction of movement of the primary part and secondary part.

In addition to the aforementioned components, the linear drive system may comprise further components. These include, for example, components with the aid of which a guide or bearing of the movable primary part (or of the movable secondary part in the case of an inverse embodiment) may be achieved. Examples are guide rails with movable rollers or balls, as well as corresponding retaining elements.

In a further embodiment, the linear drive system comprises a main controller configured to control the operation of the drive system. The main controller may be connected to the primary part via a cable, which in the case of a movable embodiment of the primary part may be realized as a trailing cable or cable drag chain. With the aid of the main controller, the energization of the electromagnet device of the primary part and thus the movement of the primary part and secondary part relative to each other may be controlled.

The initial measurement and the position determination may also be controlled with the aid of the main controller or carried out with the participation of the main controller. In this context, the reference magnetic field data as well as the current magnetic field data, which may be obtained by detecting the magnetic field of the magnet arrangement of the secondary part with the aid of the sensor device, may be stored in the main controller. Based on the reference magnetic field data and the current magnetic field data, the main controller may determine the current position of the primary part with respect to the secondary part. The embodiments of the method described below may also be carried out by the main controller or may be carried out as part of an evaluation by the main controller.

In a further embodiment, the position determination comprises carrying out a comparison of at least part of the current magnetic field data with parts of the reference magnetic field data using a similarity method. Using such a method, which may also be referred to as a correlation method, the position determination may be carried out with a high reliability and accuracy. In the similarity method, data sets or partial data sets may be compared to one another. With reference to the provided reference magnetic field data and the current magnetic field data, at least one partial data set of the current magnetic field data may be compared to a plurality of partial data sets of the reference magnetic field data. The partial data sets of the reference magnetic field data may, based on the initial measurement, reflect different positions of the primary part with respect to the secondary part, so that the current position of the primary part may be at least roughly concluded on the basis of the comparison.

In a further embodiment, the similarity method used is a DTW (dynamic time warping) method. The DTW method allows for determining a position with a high degree of simplicity, and may therefore be reliably carried out even with data sets having a relatively small number of data points. A further advantage is a high degree of flexibility, which means that data sets may be compared reliably even if they have different numbers of data points or if there is a temporal or spatial offset, for example due to a sampling used as part of magnetic field detection.

By carrying out a DTW procedure or algorithm, the similarity of two sets of data to be compared may be determined. The method may include steps such as generating a distance matrix and determining the most efficient path through the distance matrix. The method may further determine a similarity measure referred to as the DTW distance. The lower the DTW distance, the more similar the compared data sets are.

In a further embodiment, it is provided that the reference magnetic field data comprises a plurality of magnetic field patterns. The magnetic field patterns, which represent partial data sets of the reference magnetic field data, are each assigned to a magnet group composed of permanent magnets of the magnet arrangement arranged next to one another. Carrying out the comparison may be done using the magnetic field patterns. This allows the position to be determined with a high degree of reliability and accuracy.

With reference to the aforementioned embodiment, a division of the permanent magnets of the magnet arrangement of the secondary part into a plurality of magnet groups is used for the purpose of position determination. The magnet groups, to each of which a magnetic field pattern is assigned, may each comprise, for example, two permanent magnets arranged next to one another and polarized inversely to one another, and as a result a pair of permanent magnets in each case. It may further be provided that the magnet groups each comprise a larger number of permanent magnets or pairs of permanent magnets, for example four permanent magnets arranged next to each other and thus two pairs of permanent magnets arranged next to each other. The sensor device of the primary part may be embodied in terms of dimensions in such a way that, with the aid of the magnetic field sensors, an overlap of one or of a plurality of pairs of permanent magnets and thus an overlap of a magnet group may be achieved, with reference to the direction of movement of the primary part and secondary part.

The magnetic field patterns, which may also be referred to as reference patterns or templates, may be applied in the comparison with the current magnetic field data. Carrying out the comparison may include at least one of the following: comparing the current magnetic field data with the magnetic field patterns; comparing at least a part (i.e., at least a partial data set) of the current magnetic field data with at least a partial pattern of the magnetic field patterns; comparing the current magnetic field data with magnetic field patterns newly composed of the magnetic field patterns (or parts or partial patterns thereof); and/or comparing a plurality of parts or partial data sets of the current magnetic field data with partial patterns of the magnetic field patterns. Possible embodiments in this regard are discussed in more detail below.

A possible procedure for providing the magnetic field patterns is described below. In a further embodiment, the primary part and the secondary part are moved relative to each other in the initial measurement. The magnetic field patterns are provided based on the detected magnetic field of the magnet arrangement of the secondary part, which is detected with the aid of the sensor device when the magnetic field sensors of the sensor device are each located in the area of a magnet group. In other words, the provision of a magnetic field pattern for a magnet group is carried out on the basis of the detected magnetic field in each case when an overlap of the relevant magnet group by the magnetic field sensors occurs, with respect to the direction of movement of the primary part and secondary part. In this way, the magnetic field patterns may be provided in a simple manner. The magnetic field patterns may be stored in the main controller of the linear drive system.

In a further embodiment, it is determined whether the magnetic field sensors of the sensor device are each located in the area of a magnet group (and thus if an overlapping of a magnet group occurs) on the basis of zero crossings of a course of a magnetic field component of the magnetic field of the magnet arrangement of the secondary part, which is detected with the aid of an end-side magnetic field sensor of the sensor device. The end-side magnetic field sensor is located, with respect to the direction of movement of the primary part and the secondary part, at one end or edge of the arrangement of magnetic field sensors of the sensor device.

The magnetic field component considered may be detected in a direction oriented perpendicular with regard to the direction of movement of the movable primary part (or movable secondary part in the case of an inverse embodiment). Here, the zero crossings may reflect boundaries of adjacent permanent magnets and pairs of permanent magnets of the magnet arrangement of the secondary part, which may be used for determining whether the magnetic field sensors of the sensor device are located in the area of a magnet group. If the end-side magnetic field sensor is located at or in the vicinity of a boundary in each case and there is thus an overlap of a magnetic group by the magnetic field sensors of the sensor device, this may be detected on the basis of a zero crossing of the course of the magnetic field component detected with the end-side magnetic field sensor. The provision of the magnetic field pattern may be carried out in accordance with this.

With regard to the position of the primary part to be determined, it is possible that the magnetic field sensors of the sensor device in the current position of the primary part are located in the area of a magnet group of the magnet arrangement of the secondary part, and thus an overlap of the magnet group by the magnetic field sensors occurs. In this case, by comparing the current magnetic field data (obtained at the current position) to the magnetic field patterns associated with the magnet groups, it is possible to determine a magnetic field pattern with the largest similarity, thus the associated magnet group, hence a positioning of the sensor device at the relevant magnet group and consequently the current position of the primary part.

However, in the current position of the primary part, the sensor device may also be located at an offset in the area of two adjacent magnet groups of the magnet arrangement of the secondary part, so that the two magnet groups are each partially overlapped by the sensor device with reference to the direction of movement of the primary part and of the secondary part. In such a case, carrying out the comparison may be coordinated with this or carried out with data coordinated with this, as will be described further below.

In a further embodiment, the position determination comprises determining a sensor position of the sensor device with respect to a boundary of two adjacent magnet groups or of two adjacent pairs of permanent magnets in the current position of the primary part. Furthermore, determining the position of the primary part or carrying out the comparison is carried out taking into account the determined sensor position of the sensor device. In this way, for example, an offset positioning of the sensor device in the area of two adjacent magnet groups may be taken into account and an accurate position determination may also be realized in such a case.

In a further embodiment, determining the sensor position of the sensor device is carried out on the basis of a zero crossing of a course of a magnetic field component of the magnetic field of the magnet arrangement of the secondary part, which is reproduced by the current magnetic field data. According to the embodiment described above in connection with providing magnetic field patterns, the magnetic field component considered may be the magnetic field component detected in a direction perpendicular with regard to the direction of movement of the primary part and of the secondary part. In this case, a boundary of two adjacent magnet groups or pairs of permanent magnets may be detected on the basis of a zero crossing in the course of the magnetic field component reproduced by the current magnetic field data, and in this respect the sensor position of the sensor device may be determined with respect to such a boundary.

If there is no zero crossing coinciding with a boundary of neighboring magnet groups or pairs of permanent magnets in the course of the magnetic field component considered and represented by the current magnetic field data or in the area of the ends of the course of the magnetic field component considered, a sensor position may be detected in which the sensor device may be located in the area of a magnet group or an overlap of a magnet group by the sensor device may be present. If this is not the case, or if a zero crossing coinciding with a boundary of neighboring magnet groups or pairs of permanent magnets is present in the course of the magnetic field component under consideration, a sensor position may be detected in which the sensor device is located in the area of two neighboring magnet groups and a partial overlap of the neighboring magnet groups by the sensor device may be provided.

Determining the sensor position with respect to a boundary of two adjacent magnet groups or permanent magnet pairs of the magnet arrangement of the secondary part may further comprise determining a distance, related to the direction of movement, between the boundary and one or a plurality of magnetic field sensors of the sensor device arranged closest to the boundary in the current position of the primary part. For this purpose, one or a plurality of magnetic field sensors arranged closest to the boundary may be identified on the basis of the course of the magnetic field component and the zero crossing reproduced by the current magnetic field data. Based on this or by carrying out an interpolation or extrapolation, the distance between the boundary and one or a plurality of magnetic field sensors located closest to the boundary may be determined. The interpolation or extrapolation may be carried out considering a distance between magnetic field sensors of the sensor device.

In case of a staggered positioning of the sensor device in the area of two adjacent magnet groups, the sensor device may overlap a boundary between the adjacent magnet groups, and a plurality of or two magnetic field sensors located closest to the boundary may be arranged on both sides of the boundary. In this context, for determining the distance between the boundary and one or a plurality of magnetic field sensors located closest to the boundary, an interpolation or extrapolation may be carried out taking into account the distance between the respective magnetic field sensors.

It is possible that all magnetic field sensors are arranged equidistant with regard to one another with respect to the direction of movement. In this way, the aforementioned method step may be carried out using a uniform distance between the magnetic field sensors. However, there may also be a non-equidistant arrangement of the magnetic field sensors, wherein the aforementioned step may be carried out using the associated distance between the magnetic field sensors in question in order to achieve a corresponding accuracy.

In order to determine the distance between the magnetic field sensors, the following procedure may be carried out. In this case, a total distance between end magnetic field sensors of the sensor device, which are located at opposite ends of the arrangement of magnetic field sensors, with regard to the direction of movement may be provided, for example by measuring the sensor device. Furthermore, phase shifts of courses of a magnetic field component of the magnetic field of the magnet arrangement of the secondary part detected with the aid of the magnetic field sensors may be determined in each case. This may be carried out as part of the initial measurement, in which the primary part and the secondary part may be moved relative to each other as indicated above. The magnetic field component may be that magnetic field component which is detected in a direction perpendicular to the direction of movement. Based on the total distance and the phase shifts, distances from adjacent magnetic field sensors of the sensor device related to the direction of movement may be determined. Based on this, the determination of the distance between the boundary and the magnetic field sensors arranged closest to the boundary as described above may be carried out.

A positioning of the sensor device in the area of a magnet group of the magnet arrangement of the secondary part, so that an overlap of the magnet group by the magnetic field sensors occurs, may be detected as indicated above by determining the sensor position of the sensor device with respect to a boundary of two adjacent magnet groups or of two adjacent pairs of permanent magnets. In this context, the boundary may be present in the region of an edge or end of the sensor device. This may be determined on the basis of a course of a magnetic field component of the magnetic field of the magnet arrangement of the secondary part, which is reproduced by the current magnetic field data. The magnetic field component in question may be detected in a direction oriented perpendicular with regard to the direction of movement of the primary part and of the secondary part. A sensor position of the sensor device in the area of a magnet group may in this context be recognized by the fact that in the relevant course of the magnetic field component, at least in the area of its ends, there is no zero crossing coinciding with a boundary of adjacent magnet groups or pairs of permanent magnets.

In the case of such a positioning of the sensor device in the area of a magnetic group, the current magnetic field data may be compared to the magnetic field patterns of the reference magnetic field data for position determination of the primary part, as indicated above, in order to determine a magnetic field pattern with the greatest similarity, and thus the associated magnetic group. For position determination, the distance between a boundary of adjacent magnetic groups or pairs of permanent magnets and a magnetic field sensor located closest to the boundary, based on the direction of movement, may also be determined. For this purpose, an extrapolation may be carried out using the course of the magnetic field component reproduced by the current magnetic field data.

As described above, by determining the sensor position, it may further be determined that the sensor device in the current position of the primary part is located in the area of two neighboring magnet groups, so that both magnet groups are each partially overlapped by the sensor device. In the presence of such a sensor position, the following embodiment may be applied with regard to carrying out the comparison. Here, a partial data set is formed from the current magnetic field data, which was obtained with the aid of a sensor subgroup of magnetic field sensors of the sensor device, by which the partial overlap of one of the two magnet groups is established. Further, partial patterns are formed from the magnetic field patterns taking into account the partial overlap. For carrying out the comparison, the partial data set of the current magnetic field data is compared to the partial patterns of the magnetic field patterns.

In the aforementioned embodiment, a partial overlap of a magnet group by a part of the sensor device determined on the basis of the sensor position is taken into account. In this context, a sensor subgroup of magnetic field sensors of the sensor device is located in the area of the relevant magnet group, and the magnet group is thus overlapped by the sensor subgroup. Based on this, a partial data set is selected from the current magnetic field data, which was obtained using the sensor subgroup overlapping the magnet group. Similarly, partial patterns relating to the partial overlap are formed from the magnetic field patterns. As indicated above, the magnetic field patterns each relate to a magnet group of the magnet arrangement of the secondary part. The partial patterns formed from this reflect the partial overlap determined on the basis of the sensor position and effected by the sensor subgroup with respect to each of the magnet groups associated with the magnetic field patterns.

In the following similarity comparison, the partial data set of the current magnetic field data are compared to the partial patterns of the magnetic field patterns. In this way, a partial pattern and consequently a magnetic field pattern having the greatest similarity, thus the associated magnet group and insofar as positioning of the sensor device at the relevant magnet group, may be determined. Based on this or with additional consideration of the sensor position of the sensor device, the current position of the primary part may be determined.

With respect to the aforementioned embodiment, the sensor position may be used to determine, for example, that two adjacent groups of magnets are overlapped by the sensor device to different degrees. In this case, forming the partial data set from the current magnetic field data and forming the partial patterns from the magnetic field patterns with reference to the larger partial overlap and larger sensor subgroup may be carried out from magnetic field sensors to achieve high accuracy.

It is also possible to carry out the similarity comparison with respect to both partial overlaps of the two adjacent magnet groups, thereby determining one partial pattern with the greatest similarity and one associated magnet group for each partial overlap. This may further improve the reliability and accuracy of the position determination. A plausibility check may also be achieved by this procedure. It is required that the partial patterns determined with the greatest similarity belong to two adjacent magnet groups. If this is not the case, an error may be identified, for example in the data used.

In a further embodiment, the following procedure is used when a sensor position of the sensor device is detected in the area of two adjacent magnet groups, so that both magnet groups are partially overlapped by the sensor device in each case. Here, composed magnetic field patterns are formed, which are composed of partial patterns of magnetic field patterns of two adjacent magnet groups, in each case taking into account the partial overlaps. To carry out the comparison, the current magnetic field data are compared to the composed magnetic field patterns.

In the aforementioned embodiment, an overlap of two neighboring magnet groups determined on the basis of the sensor position, wherein a partial overlap exists for both magnet groups in each case by the sensor device, is taken into account. In this case, partial patterns of magnetic field patterns relating to the partial overlaps, which each relate to two adjacent magnet groups, are selected, and these are combined to form new magnetic field patterns. The newly composed magnetic field patterns reflect the positioning of the sensor device determined on the basis of the sensor position and thus the overlap caused by the sensor device in relation to two neighboring magnet groups in each case.

In the similarity comparison carried out subsequently, the current magnetic field data are compared to the composed magnetic field patterns. In this way, a composed magnetic field pattern with the greatest similarity may be determined, thus the two neighboring magnet groups belonging to the composed magnetic field pattern, and insofar as positioning of the sensor device at the two magnet groups concerned. Based on this or with additional consideration of the sensor position of the sensor device, the current position of the primary part may be determined.

The method described below may also be used if, in the current position of the primary part, a sensor position of the sensor device is present or detected in the area of two adjacent magnet groups, and both magnet groups are thereby partially overlapped by the sensor device.

In a further embodiment, the current magnetic field data are divided up into partial data sets, each of which was obtained with the aid of a sensor subgroup of magnetic field sensors of the sensor device partially overlapping the magnet arrangement. Furthermore, partial patterns are formed from the magnetic field patterns taking into account the sensor position of the sensor device and taking into account the partial overlaps by the sensor subgroups. For carrying out the comparison, the partial data sets are compared to the partial patterns.

The aforementioned embodiment is based on a division of the magnetic field sensors of the sensor device into a plurality of sensor subgroups, each of which provides partial overlap of the magnet arrangement of the secondary part. The sensor subgroups may each comprise the same number of magnetic field sensors. Based on this, a plurality of partial data sets are selected from the current magnetic field data obtained using the sensor subgroups each partially overlapping the magnet arrangement. In the same way, taking into account the sensor position of the sensor arrangement present in the current position, partial patterns relating to the partial overlaps are formed from the magnetic field patterns.

With the aid of the partial patterns, the partial overlaps caused by the sensor subgroups may be reproduced in each case with reference to two neighboring magnet groups. In the case that an overlap of the boundary of the neighboring magnet groups for a sensor subgroup occurs, those partial patterns which reproduce the partial overlap caused by this sensor subgroup may be formed by composing parts of magnetic field patterns of neighboring magnet groups. Depending on the division of the magnetic field sensors, a plurality of sensor subgroups may also overlap the boundary. In a corresponding manner, the partial patterns relating to the partial overlaps of these sensor subgroups may be composed by parts of magnetic field patterns of neighboring magnet groups.

In the following similarity comparison, the partial data sets are compared to the respective corresponding partial patterns with regard to the sensor position and the division of the magnetic field sensors and thus the partial overlaps caused by the sensor subgroups. In this way, the partial patterns with the greatest similarity may be determined. This makes it possible to determine those two adjacent magnet groups and thus a positioning of the sensor device at those two adjacent magnet groups which belong to the determined partial patterns. Based on this or with additional consideration of the sensor position of the sensor device, the current position of the primary part may be determined.

With the aid of the aforementioned embodiment, in which a plurality of partial data sets are compared to a plurality of partial patterns, the reliability and accuracy of the position determination may be further favored. Furthermore, this embodiment also allows for a plausibility check. In this context, the requirement is that two neighboring magnet groups are determined in a matching manner based on the partial patterns determined with the greatest similarity. If this is not the case, it may be concluded that there is an error, for example in the data used.

With regard to the embodiments described above, in which carrying out the comparison is done in different ways, it is possible to carry out several of the different embodiments to determine the position of the primary part with respect to the secondary part. Also in this way, the reliability of the position determination may be favored, and moreover, a plausibility check is possible.

With reference to the embodiments described above, supplementary reference is made to the following. As described above, a division of the permanent magnets of the magnet arrangement of the secondary part may be provided, according to which the magnet groups each comprise a plurality of permanent magnet pairs of inversely polarized permanent magnets. The sensor arrangement of the primary part may be embodied in terms of dimensions in such a way that, with the aid of the magnetic field sensors, it is possible to achieve an overlap of such a magnet group, with reference to the direction of movement of the primary part and secondary part.

In this context, it is possible that the sensor device in the current position of the primary part and in the presence of an offset sensor position overlaps a plurality of boundaries of adjacent permanent magnet pairs or magnet groups, which may be determined in a corresponding manner on the basis of zero crossings of a course of a magnetic field component of the magnetic field of the magnet arrangement of the secondary part reproduced by the current magnetic field data. The method variants for position determination described above may be carried out in this case with respect to one of the boundaries.

As indicated above, the current position of the primary part with respect to the secondary part determined according to the method may be a resting position, so that no movement generation occurs in the linear drive system when this position is present. Starting from this position, the primary part and the secondary part may be moved relative to each other. In this context, the current position determined according to the method may be used as a reference position to which subsequently carried out movements and thus position changes of the primary part with respect to the secondary part may be referenced. The position changes may be determined on the basis of the magnetic field of the magnet arrangement of the secondary part detected by one or a plurality of magnetic field sensors of the sensor device. This may be done in an incremental manner, for example, by determining the position changes with respect to individual permanent magnet pairs or magnet groups of the magnet arrangement. Based on this, incrementing of a corresponding counter may take place.

The aforementioned steps, such as the previously described steps (initial measurement, position determination using the current magnetic field data and the reference magnetic field data), may be carried out with the aid of the main controller of the linear drive system or by carrying out a corresponding evaluation by the main controller.

A linear drive system is proposed. The linear drive system may be configured to carry out the method described above, or to carry out one or a plurality of the embodiments of the method described above. The linear drive system comprises a primary part and a secondary part, which may be moved in a translatory manner relative to each other. The primary part comprises an electromagnet device that may be energized, and the secondary part comprises a magnet arrangement comprising permanent magnets arranged next to each other. By energizing the electromagnet device of the primary part, a magnetic interaction between the electromagnet device and the magnet arrangement of the secondary part may be caused to move the primary part and the secondary part relative to each other.

The primary part comprises a sensor device having magnetic field sensors for detecting a magnetic field generated by the magnet arrangement of the secondary part. The linear drive system is embodied to detect the magnetic field of the magnet arrangement of the secondary part in an initial measurement at different positions of the primary part with respect to the secondary part using the sensor device and to provide position-dependent reference magnetic field data. The linear drive system is further configured to carry out a position determination for the primary part. For this purpose, the magnetic field of the magnet arrangement of the secondary part is detected at a current position of the primary part with respect to the secondary part using the sensor device and current magnetic field data are provided. Based on the reference magnetic field data and the current magnetic field data, the current position of the primary part with respect to the secondary part is determined.

For the linear drive system, the same features, details and embodiments may be applied and the same advantages may be considered as described above with reference to the method. In that the linear drive system uses the secondary part already used for movement generation together with the sensor device of magnetic field sensors provided on the primary part for position determination, the use of additional space-consuming attachments may be omitted. As a result, space savings may be achieved and position determination may be implemented cost-effectively.

Based on the following schematic figures, embodiments of a linear drive system and of a method for operating a linear drive system are described. The linear drive system comprises a primary part and a secondary part, which may be moved in a translatory manner relative to each other. The operation of the linear drive system comprises carrying out a position determination for the primary part, which is done, inter alia, by using a magnetic field generated by the secondary part. In this way, the position determination may be realized in a space-saving manner.

With reference to the embodiments described below, it is noted that aspects and details mentioned with respect to one embodiment may also be applied to another embodiment.

Furthermore, it is possible to combine features of a plurality of embodiments. In addition, it is pointed out that the figures are merely schematic in nature. In this respect, components and details shown in the figures may not be to scale, but may be shown exaggeratedly large or reduced in size. In the case of diagrams, it is pointed out that axis labels may be arbitrary units.

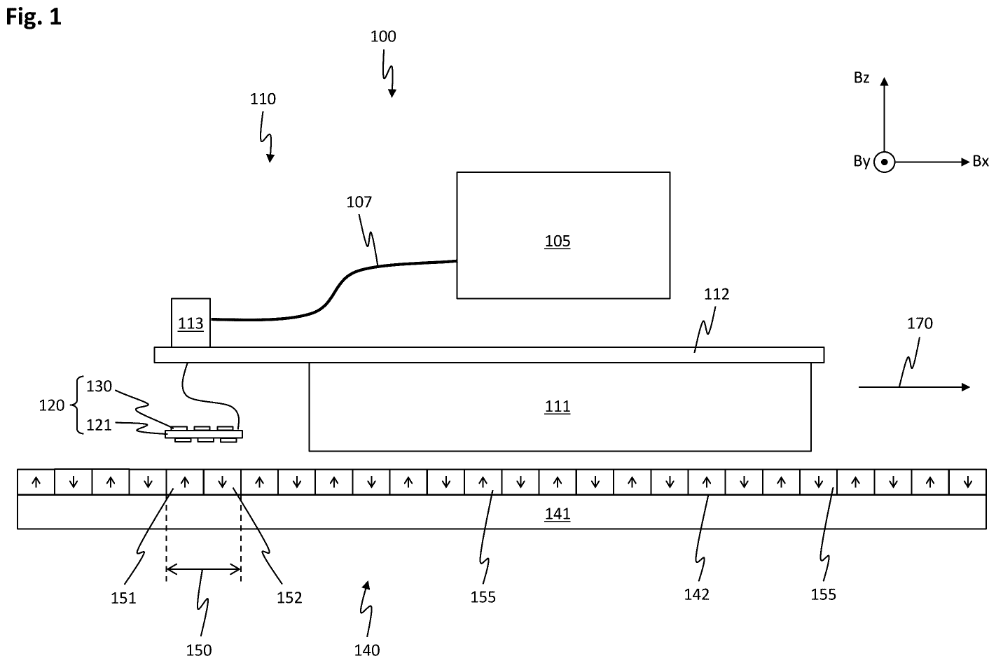

FIG. 1 shows a possible embodiment of a linear drive system 100 in a lateral view. The linear drive system 100 comprises a primary part 110 and a secondary part 140, which may be moved in a translatory manner relative to each other. In the present embodiment, the secondary part 140 is a stationary component and the primary part 110 is a movable component of the linear drive system 100, so that the primary part 110 may be moved relative to the secondary part 140. Here, the primary part 110 may also be referred to as a carriage and the secondary part 140 may be referred to as a magnetic plate. In FIG. 1, an arrow indicates a direction of movement 170. A movement of the primary part 110 along the direction of movement 170 may take place both in the direction indicated by the arrow and in a direction opposite thereto.

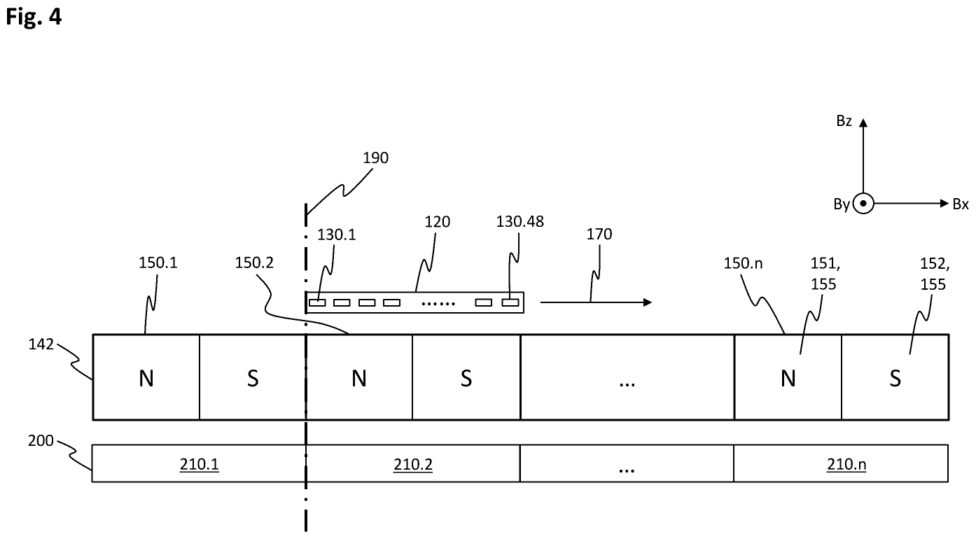

For movement generation, the primary part 110 comprises a current-carrying electromagnet device 111, and the secondary part 140 comprises a magnet arrangement 142 having a plurality of permanent magnets 155 arranged next to each other along the direction of movement 170. The permanent magnets 155 are arranged in such a way that adjacent permanent magnets 155 are arranged opposite to one another with respect to their polarity and in this way an alternation of polarity occurs along the direction of movement 170. This arrangement is indicated in FIG. 1 by arrows with different arrow directions. The permanent magnets 155, which are oriented differently with respect to polarity, are also referred to below as first permanent magnets 151 and second permanent magnets 152. The first permanent magnets 151 may comprise a magnetic north pole on the side facing the primary part 110, as indicated by the arrow pointing upwards. Similarly, the second permanent magnets 152 may comprise a magnetic south pole on the side facing the primary part 110, as indicated by the downward pointing arrow. In subsequent figures (for example, FIG. 4), the different polarity is indicated by the letters N (for north pole) and S (for south pole) instead of arrows.

The electromagnet device 111 of the primary part 110 comprises a plurality of energizable electromagnets in the form of coils. By energizing the electromagnets, which may include applying a three-phase current to the electromagnets, a varying magnetic field may be generated by the electromagnet device 111. The varying magnetic field may interact with the magnetic field provided by the permanent magnet arrangement 142 of the secondary part 140, which may cause the translatory movement of the primary part 110 relative to the secondary part 140.

As shown in FIG. 1, the secondary part 140 comprises, in addition to the magnet arrangement 142, a carrier plate 141 on which the permanent magnets 155 are arranged. The primary part 110 comprises a housing 112, shown only schematically in FIG. 1, inside of which the electromagnet device 111 is arranged. The primary part 110 also comprises a sensor device 120, which is likewise arranged within the housing 112 and is embodied to detect the magnetic field generated by the magnet arrangement 142 of the secondary part 140. This is used in the context of a position determination for the primary part 110, as will be described further below. For this purpose, the sensor device 120 comprises a plurality of magnetic field sensors 130 and a printed circuit board 121 on which the magnetic field sensors 130 are arranged. The magnetic field sensors 130 may be positioned on one side or, as shown in FIG. 1, on two opposite sides of the circuit board 121. In this case, the magnetic field sensors 130 may be arranged distributed in one or also in two planes. The magnetic field may be detected by scanning.

The magnetic field sensors 130 of the sensor device 120 are embodied to detect the magnetic field of the magnet arrangement 142 or its magnetic flux density in three different directions and thus, as indicated by arrows in FIG. 1, three different magnetic field components Bx, By, Bz of the magnetic field. A first magnetic field component Bx refers to a direction parallel with regard to the direction of movement 170, whereas a second magnetic field component By and a third magnetic field component Bz refer to directions perpendicular with regard thereto. The first and second magnetic field components Bx, By further relate to directions parallel with regard to a plane defined by the magnet arrangement 142, whereas the third magnetic field component Bz relates to the direction vertical thereto. The magnetic field sensors 130 may be realized in the form of Hall sensors or 3D Hall sensors. Another embodiment is possible, as well, for example in the form of MR sensors (magnetoresistive sensors).

The linear drive system 100 further comprises, as shown in FIG. 1, a main controller 105 which is configured to control the operation of the linear drive system 100. For this purpose, the main controller 105 is connected, via a connecting cable 107, to a connector 113 of the primary part 110, which is arranged on the housing 112 thereof and to which the electromagnet device 111 and the sensor device 120 of the primary part 110 are connected. With regard to the movable embodiment of the primary part 110, the connecting cable 107 is embodied, for example, as a trailing cable or cable drag chain.

Via the connector between the main controller 105 and the primary part 110 realized in this manner, the main controller 105 may control the energization of the electromagnet device 111. This may cause a corresponding movement of the primary part 110. Furthermore, the sensor device 120 may be used to detect the magnetic field of the magnet arrangement 142 of the secondary part 140. Based thereon, magnetic field data may be provided, which may be stored in the main controller 105. For this purpose, a data communication realized, inter alia, via the connecting cable 107 and interfaces may take place between the sensor device 120 and the main controller 105, wherein sensor signals or sensor data obtained in the course of the magnetic field measurement by the sensor device 120 may be transmitted to the main controller 105.

In addition to the components shown in FIG. 1 and described above, the linear drive system 100 may comprise further components. This relates to components for guiding or supporting the movable primary part 110 on or relative to the stationary secondary part 140. In this context, for example, guide rails with movable rollers or balls, as well as retaining elements corresponding thereto and arranged or embodied on the housing 112 of the primary part 110 may be included.

According to the embodiment shown in FIG. 1, the sensor device 120 is dimensionally embodied in such a way that, with the aid of the magnetic field sensors 130, a complete or substantially complete coverage or overlap of two permanent magnets 155, with reference to the direction of movement 170, may be achieved. The magnetic field sensors 130 of the sensor device 120 are further distributed and spaced apart from one another, also with respect to the direction of movement 170. For the purpose of determining the position, such an allocation or division of the permanent magnets 155 of the magnet arrangement 142 of the secondary part 140 is provided, coordinated with the sensor device 120, according to which in each case a permanent magnet pair comprising two inversely polarized permanent magnets 155 or a pair comprising a first and second permanent magnet 151, 152 are combined to form a magnet group 150.

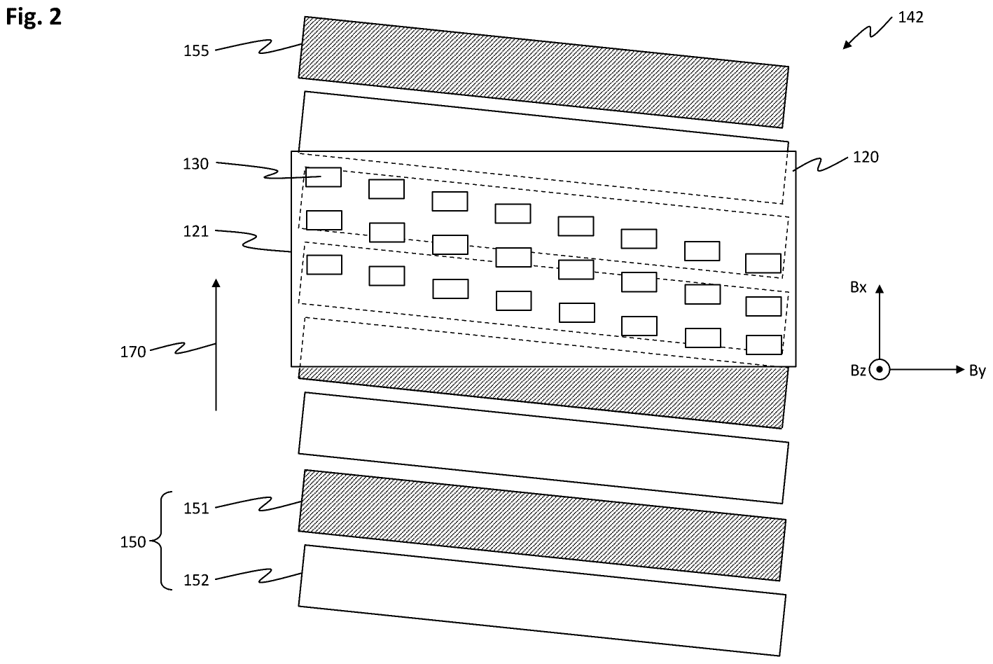

FIG. 2 shows a top view of the sensing device 120 of the primary part 110 and the magnet arrangement 142 of the secondary part 140. The permanent magnets 155 of the magnet arrangement 142 have an elongated shape and are arranged in parallel with regard to one another with respect to their longitudinal axes. The longitudinal axes of the permanent magnets 155 are substantially oriented perpendicularly with regard to the direction of movement 170. Here, the orientation of the longitudinal axes of the permanent magnets 155 deviates somewhat from an exactly perpendicular orientation in that the longitudinal axes are oriented obliquely or slightly obliquely with respect to the direction of movement 170. This embodiment serves to suppress a possible occurrence of cogging during movement of the primary part 110.

FIG. 2 further shows a possible embodiment of the sensor device 120 in which the magnetic field sensors 130 are arranged in a matrix-like manner in the form of rows and columns. The arrangement is selected in such a way that, as indicated above, an overlap of a pair of permanent magnets and thus of a magnet group 150 may be achieved with the aid of the magnetic field sensors 130, and, moreover, the magnetic field sensors 130 are arranged in a distributed manner with respect to the direction of movement 170 and spaced apart from one another. Such an embodiment may be realized both with an arrangement of the magnetic field sensors 130 on one side of the circuit board 121 of the sensor device 120 and with an arrangement of the magnetic field sensors 130 on both sides of the circuit board 121, as shown in FIG. 1.

In order to reliably control the operation of the linear drive system 100 or the movement of the primary part 110 by the main controller 105, the linear drive system 100 is configured to carry out a position determination for the primary part 110. In the linear drive system 100, this is realized in a space-saving manner by carrying out the position determination using the secondary part 140 already used for the movement drive, together with the sensor device 120 of the primary part 110. This takes advantage of the fact that the magnetic field generated by the permanent magnet arrangement 142 of the secondary part 140 and measurable with the aid of the sensor device 120 may have an essentially periodic course with individual differences along the direction of movement 170. Based on this, a reliable and accurate position determination may be realized.

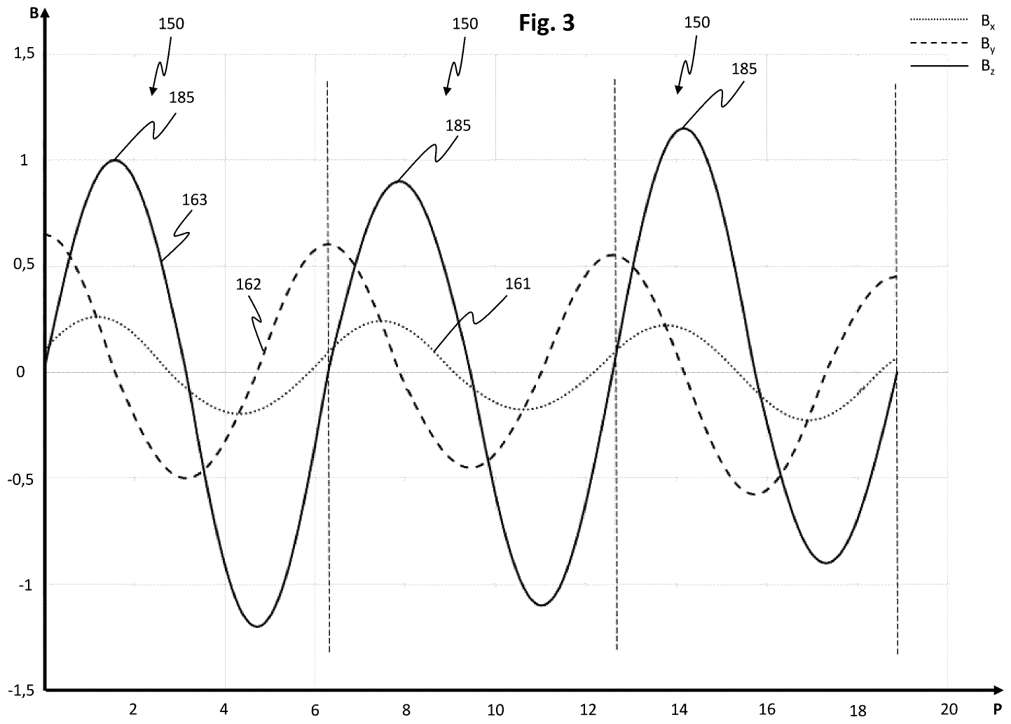

For the purpose of illustration, FIG. 3 shows a diagram having possible position-dependent courses 161, 162, 163 of a magnetic field strength for the magnetic field generated by the magnet arrangement 142 of the secondary part 140 along the direction of movement 170 and detectable by the sensor device 120 or by a magnetic field sensor 130. Shown in each case is the flux density B as a function of a position P relative to the direction of movement 170 for three magnet groups 150. A first course 161 relates to the first magnetic field component Bx, a second course 162 relates to the second magnetic field component By, and a third course 163 relates to the third magnetic field component Bz. The three courses 161, 162, 163 have a substantially sinusoidal shape, with individual differences existing from one to the next permanent pair or from one to the next magnet group 150. For example, as shown in FIG. 3, vertices 185 of the third course 163 may have different values of flux density B. This may also apply to the first and second courses 161, 162.

Such position-dependent differences in the magnetic field generated by the magnet arrangement 142 of the secondary part 140 and detectable with the aid of the sensor device 120 of the primary part 110, which may exist from permanent magnet pair to permanent magnet pair and thereby magnet group 150 to magnet group 150, may be due to tolerances of the linear drive system 100 and of its components. These may include mechanical and magnetic angular errors, magnetization errors, density differences, geometric variations, adhesive gaps, a mechanical misalignment, etc. The differences in the magnetic field are used in the linear drive system 100 to determine the position of the primary part 110 with respect to the secondary part 140. The following procedure is used for this purpose.

In an initial measurement, the magnetic field of the magnet arrangement 142 is detected or scanned at different positions of the primary part 110 with respect to the secondary part 140 using the sensor device 120. Based on this, position-dependent reference magnetic field data arc provided. These serve as the basis for the actual position determination carried out subsequently. In this context, the primary part 110 is located at an initially still unknown current position with respect to the secondary part 140. The current position may be a resting position, so that at this position (initially still) no movement is caused in the operation of the linear drive system 100 and the primary part 110 is at rest. At the current position, the sensor device 120 is again used to detect or sense the magnetic field of the magnet arrangement 142. Based on this, current magnetic field data are provided. Using the current magnetic field data and the reference magnetic field data, the current position of the primary part 110 is determined. As will be described further below, this includes carrying out a similarity process.

The initial measurement and position determination described in more detail below may also be controlled or carried out with the aid of the main controller 105 of the linear drive system 100, or may be carried out with the participation of the main controller 105. The reference magnetic field data obtained in this process by detecting the magnetic field of the magnet arrangement 142 using the sensor device 120, as well as the current magnetic field data, may be stored in the main controller 105. Through a corresponding evaluation, as described below, and which may also be carried out by the main controller 105, the current position of the primary part 110 may be determined with a high degree of reliability and accuracy based on this data.

The following embodiment is provided for the initial measurement for providing the reference magnetic field data. The initial measurement is carried out in such a way that, with the aid of the magnetic field sensors 130 of the sensor device 120, the magnetic field is in each case detected in the region of the individual magnetic groups 150 and corresponding magnetic field data are provided, which is thus associated with the relevant magnetic groups 150. The magnetic field data obtained in this way and associated with the individual magnet groups 150 are referred to below as magnetic field patterns. The reference magnetic field data comprise all provided magnetic field patterns of the magnet groups 150. The magnetic field patterns, which may be stored in the main controller 105, may also be referred to as reference patterns or templates.

For this purpose, the initial measurement may comprise moving the primary part 110 along the secondary part 140 and providing the magnetic field patterns on the basis of the magnetic field, which is detected with the aid of the magnetic field sensors 130 of the sensor device 120 in each case when the magnetic field sensors 130 are located in the region of a magnetic group 150, and in so far as, with reference to the direction of movement 170, an overlap of the relevant magnetic group 150 by the magnetic field sensors 130 occurs. For this purpose, the magnetic field may be sampled during the movement of the primary part 110 at a predetermined sampling frequency using the magnetic field sensors 130, and corresponding magnetic field data may be generated based thereon. Of this, only those magnetic field data may be used and stored as magnetic field patterns which are provided on the basis of the measured magnetic field when the magnetic field sensors 130, as indicated above, are each located in the area of a magnet group 150 and overlap it.

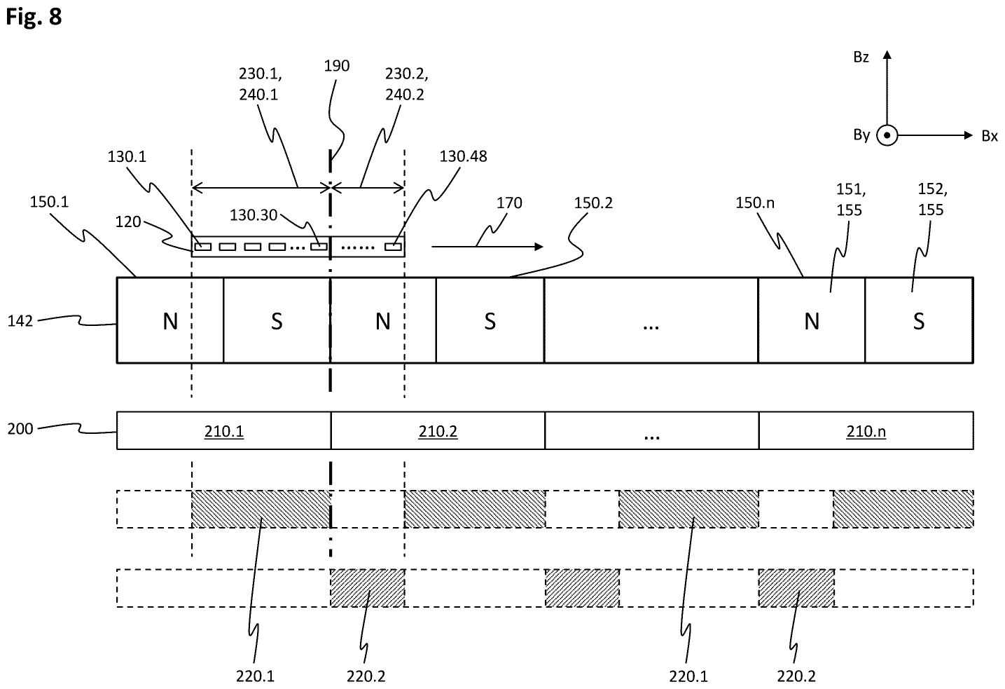

For the purpose of illustration, FIG. 4 shows a condition at a point in time such as may be present during the initial measurement. With reference to the primary part 110, only the sensor device 120 is shown, and with reference to the secondary part 140, only the magnet arrangement 142 is shown. This depiction is also chosen in subsequent figures (for example, FIG. 8). The following description is based on an exemplary embodiment of the sensor device 120 with forty-eight magnetic field sensors 130, which are distributed with reference to the direction of movement 170 and arranged at a distance from one another. To distinguish components such as the magnetic field sensors 130, indices in the form of “0.1”, “0.2”, “0.30”, “0.48” “.n”, etc. are used in FIG. 4 (and also subsequent figures). Correspondingly, the magnetic field sensors 130 identified in FIG. 4 by the reference signs 130.1 and 130.48 and located at opposite ends of the arrangement of magnetic field sensors 130 are hereinafter referred to as first magnetic field sensor 130.1 and forty-eighth magnetic field sensor 130.48.

The magnet groups 150 of the magnet arrangement 142 are also provided with indices, wherein an arrangement comprising a first magnet group 150.1, a second magnet group 150.2, etc. up to a nth magnet group 150.n is provided, wherein n may be 100, for example. With regard to the first magnet group 150.1, it is pointed out that, in deviation from FIG. 4, this cannot be a magnet group 150 located at a (left) end of the magnet arrangement 142, and in this respect may only be considered as the first magnet group 150.1 for the following description. To the left of the first magnet group 150.1, at least one further pair of permanent magnets and thus at least one further magnet group 150 may be provided.

In FIG. 4, the magnetic field patterns 210 of the reference magnetic field data 200 associated with the individual magnetic groups 150 are also shown schematically and corresponding to the positions of the magnetic groups 150. These are also provided with indices, so that a first magnetic field pattern 210.1, a second magnetic field pattern 210.2, etc. up to an nth magnetic field pattern 210.n is provided.

According to FIG. 4, the sensor device 120 is located in the area of the second magnetic group 150.2 during the initial measurement, in which the primary part 110 and thus the sensor device 120 are moved from left to right, for example, so that the second magnetic group 150.2 is overlapped by the magnetic field sensors 130. The magnetic field data obtained in this state by detecting the magnetic field with the aid of the magnetic field sensors 130 forms the second magnetic field pattern 210.2 associated with the second magnetic group 150.2. The other magnetic field patterns 210 of the reference magnetic field data 200 are provided in a corresponding manner based on the magnetic field detected by the magnetic field sensors 130 when the sensor device 120 or its magnetic field sensors 130 are each located in the region of an associated magnetic group 150 and overlap it.

In this context, carrying out the initial measurement further comprises determining that the magnetic field sensors 130 of the sensor device 120 are each located in the region of a magnet group 150 and that as a result an overlap of the magnet group 150 occurs in order to carry out the above-described provision of the magnetic field patterns 210 of the magnet groups 150 on the basis thereof or in coordination therewith. For this purpose, use is made of the fact that, on the basis of the magnetic field measured by the sensor device 120, boundaries 190 between pairs of permanent magnets and thereby between the magnet groups 150 may be detected, and thereby a presence of the magnetic field sensors 130 in the region of the individual magnet groups 150 may be detected. In FIG. 4, such a boundary 190 between the first and second magnet groups 150.1, 150.2 is illustrated by a dashed line.

The boundaries 190 of neighboring pairs of permanent magnets and groups of magnets 150 may be represented by positive (i.e., with positive slope) zero crossings of a magnetic field strength course of the third magnetic field component Bz obtained during the initial measurement along the direction of movement 170. Based on this, the limits 190 may be determined. Therefore, for determining that the magnetic field sensors 130 are each located in the area of a magnetic group 150, the course of the third magnetic field component Bz detected with the aid of an end-side magnetic field sensor 130 (which is located at one end of the arrangement of magnetic field sensors 130) may be used.

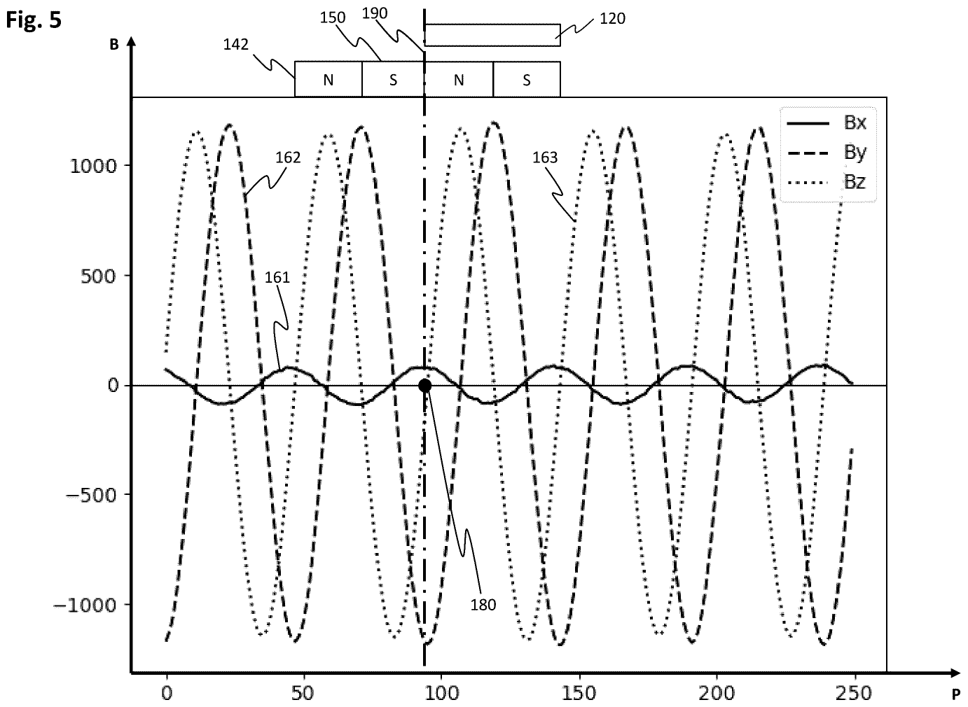

For example, the first magnetic field sensor 130.1 may be used for this purpose. In this context, FIG. 5 shows a diagram with courses 161, 162, 163 of the magnetic field strength relating to the different magnetic field components Bx, By, Bz, which may be obtained in the initial measurement by detecting the magnetic field with the aid of the first magnetic field sensor 130.1. FIG. 5 also shows a positive zero crossing 180 of the third course 163 relating to the third magnetic field component Bz, by which a boundary 190 of adjacent pairs of permanent magnets and magnet groups 150 is represented.

Provided that the first magnetic field sensor 130.1 is located at or in the vicinity of a boundary 190 and thus an overlap of a magnetic group 150 by the magnetic field sensors 130 of the sensor device 120 occurs, this may be determined on the basis of a zero crossing 180 of the third magnetic field strength course 163 of the third magnetic field component Bz detected with the aid of the first magnetic field sensor 130.1 during the initial measurement. The magnetic field data obtained at such a time using all of the magnetic field sensors 130 may form a corresponding magnetic field pattern 210 or may be used as the magnetic field pattern 210. In the initial measurement in which the primary part 110 is moved along the secondary part 140, the provision of the magnetic field patterns 210 based on the magnetic field of the magnet arrangement 142 detected by the magnetic field sensors 130 may thus be coordinated in each case to determine, with the aid of the first magnetic field sensor 130.1, a presence of a zero crossing 180 at the third magnetic field component Bz measured by the first magnetic field sensor 130.1.

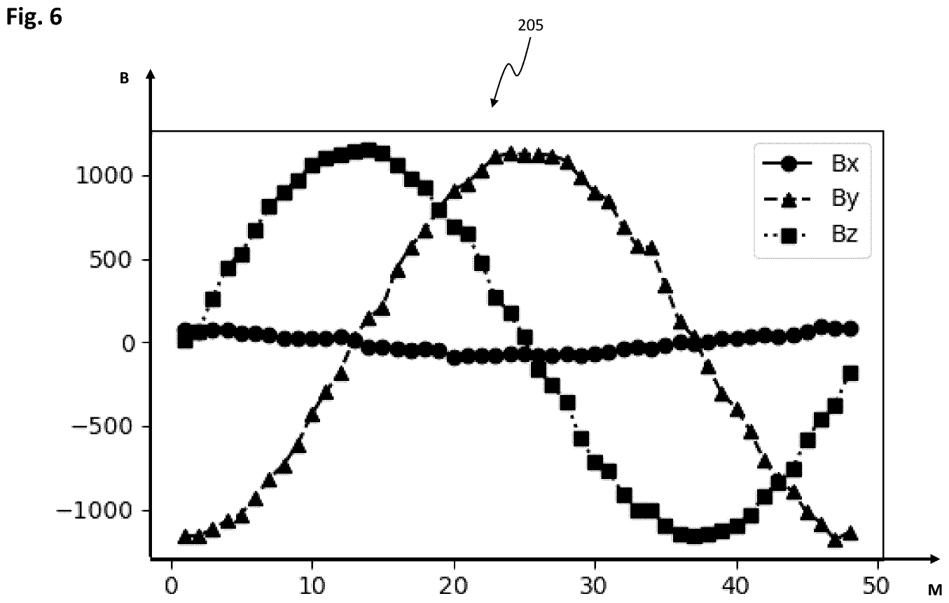

For the purpose of illustration, FIG. 6 shows a diagram with possible magnetic field data 205, which are provided by detecting the magnetic field with all magnetic field sensors 130 in the area of a magnetic group 150, for example as shown in FIG. 4 in the area of the second magnetic group 150.2, and which may be treated and used as magnetic field pattern 210 or according to FIG. 4 as second magnetic field pattern 210.2. The magnetic field data 205 shown comprise data points marked with different symbols in the form of circles, triangles and squares relating to the magnetic field components Bx, By, Bz detected by each magnetic field sensor 130 of the sensor device 120. Corresponding thereto, a number M of a magnetic field sensor 130 for the sensor device 120 comprising forty-eight magnetic field sensors 130 according to the present example is shown on the abscissa. As indicated above, the forty-eight magnetic field sensors 130 of the sensor device 120 are arranged next to each other distributed along the direction of movement 170. Corresponding to the forty-eight magnetic field sensors 130, the magnetic field data 205, and thus each magnetic field pattern 210, comprises forty-eight data points for each magnetic field component Bx, By, Bz.

Instead of the first magnetic field sensor 130.1, the forty-eighth magnetic field sensor 130.48 may also be used to detect boundaries 190 of adjacent magnetic groups 150 on the basis of the course of the third magnetic field component Bz detected by this magnetic field sensor 130.48 in the initial measurement and thereby to determine those times at which the magnetic field sensors 130 of the sensor device 120 are each located in the area of a magnetic group 150. The provision of the magnetic field patterns 210 may also be coordinated with this.

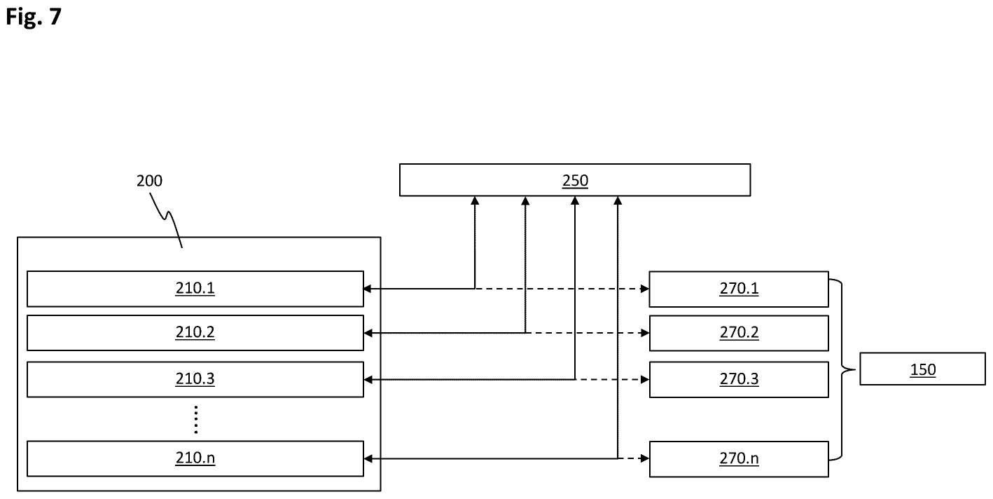

The actual position determination is carried out to determine a current position of the primary part 110 on the secondary part 140. This may be carried out, for example, after a restart or even after a power failure of the linear drive system 100. The position determination, which may be carried out as indicated above in the context of a corresponding evaluation by the main controller 105, is carried out on the basis of the current magnetic field data obtained at the current position by detecting the magnetic field of the magnet arrangement 142 using the magnetic field sensors 130 of the sensor device 120 and the reference magnetic field data 200 previously provided in the context of the initial measurement. The current magnetic field data are indicated by the reference sign 250 for the following description, in accordance with FIG. 7 described further below.

The current magnetic field data 250 comprise, corresponding to the magnetic field patterns 210 of the reference magnetic field data 200, data points for the magnetic field components Bx, By, Bz detected by each magnetic field sensor 130 of the sensor device 120, i.e. in this case corresponding to the number of magnetic field sensors 130 per magnetic field component Bx, By, Bz forty-eight data points. Accordingly, the diagram of FIG. 6 may also be used to illustrate current magnetic field data 250 obtained at a current position of the primary part 110. As will be described below, a similarity method using the current magnetic field data 250 and the magnetic field patterns 210 of the reference magnetic field data 200 is carried out to determine the position. The similarity method used is the so-called dynamic time warping (DTW) method.

By carrying out a DTW procedure or a DTW algorithm, the similarity of two data sets to be compared may be determined. The goal is to find an optimal match between the data sets when one of the data sets is mapped to the other data set in a distorted manner. This may involve a dynamic programming technique in which each data point of one data set is compared to each data point of the other data set, thereby generating a distance matrix. Here, the most efficient path through the distance matrix may be determined, which reflects an optimal mapping with the smallest total distance between the data sets. As a Result, a similarity measure may be obtained in the form of the so-called DTW distance, which may reflect the amount of distortion for the optimal mapping. The lower the DTW distance, the more similar the compared data sets are. Thus, a similarity of the data sets may be assessed.

In order to explain this procedure with respect to the position determination of the primary part 110, the following case is assumed at first. Here, the magnetic field sensors 130 of the sensor device 120 are located in the current position of the primary part 110 in the area of a magnet group 150 of the magnet arrangement 142 of the secondary part 140, wherein the relevant magnet group 150 is overlapped by the magnetic field sensors 130, according to FIG. 4.

As shown by a diagram in FIG. 7, in such a case, for the purpose of position determination, the current magnetic field data 250 may be compared to each of the magnetic field patterns 210 of the reference magnetic field data 200 using a DTW algorithm. As a result of each comparison, a distance measure 270 may be obtained in the form of the aforementioned DTW distance. Accordingly, as illustrated in FIG. 7, by comparing the current magnetic field data 250 with the first magnetic field pattern 210.1, the second magnetic field pattern 210.2, . . . the nth magnetic field pattern 210.n, a first distance measure 270.1, a second distance measure 270.2, . . . a nth distance measure 270.n may be obtained. Based on this, a magnetic field pattern 210 with the greatest similarity, i.e. for which the smallest distance dimension 270 or the smallest DTW distance is present, and thus the associated magnet group 150, may be determined. This is thus the magnet group 150 at which the sensor device 120 is located (for example, as shown in FIG. 4, the second magnet group 150.2). This information reflects the sought current position of the primary part 110 with respect to the secondary part 140.

In the current position of the primary part 110, however, the sensor device 120 may also be located at an offset in the region of two adjacent pairs of permanent magnets and thus magnet groups 150 of the magnet arrangement 142 of the secondary part 140, as a result of which the two magnet groups 150 are each partially overlapped by the magnetic field sensors 130 of the sensor device 120 with reference to the direction of movement 170. In such a case, it is possible to proceed according to the method variants described below, which are based on the previously described approach. With regard to details of corresponding features and steps, reference is therefore made to the above description. Furthermore, features and details mentioned with respect to one process variant may also be applied to another process variant. The described steps may be carried out by an evaluation with the aid of the main controller 105.

FIG. 8 shows a situation that may occur in the current position of the primary part 110. Here, the sensor device 120 is arranged at an offset in the area of two adjacent magnet groups 150, in this case the first magnet group 150.1 and the second magnet group 150.2. In this sensor position, the sensor device 120 is located above the boundary 190 of the two magnet groups 150.1, 150.2, and both magnet groups 150.1, 150.2 are each partially overlapped by the sensor device 120. As indicated in FIG. 8, both magnet groups 150.1, 150.2 thus have an overlapping region 230 related to the direction of movement 170, in which a sensor subgroup 240 of magnetic field sensors 130 of the sensor device 120 respectively overlaps one of the magnet groups 150.1, 150.2.

A first overlapping region 230.1 is provided in the first magnet group 150.1, and a second overlapping region 230.2 is provided in the second magnet group 150.2. Thirty magnetic field sensors 130 of the sensor device 120, i.e., the first magnetic field sensor 130.1 to a thirtieth magnetic field sensor 130.30, are located in the first overlapping region 230.1. The thirty magnetic field sensors 130 belonging to the first overlapping region 230.1 constitute a first sensor subgroup 240.1. In the second overlapping region 230.2, there are a further eighteen magnetic field sensors 130 of the sensor device 120, that is, from a thirty-first magnetic field sensor 130.48, to a forty-eighth magnetic field sensor 130.48. The eighteen magnetic field sensors 130 belonging to the second overlapping region 230.2 form a second sensor subgroup 240.2.

In order to take such circumstances into account, it is provided to determine a sensor position of the sensor device 120 with respect to a boundary 190 of two adjacent magnet groups 150 in the current position of the primary part 110. The determination of the position of the primary part 110 or the carrying out of the comparison described above with reference to FIG. 7 is thereby carried out in consideration of and in coordination with the determined sensor position. The determination of the sensor position is carried out, similarly to the provision of the magnetic field patterns 210 described above, on the basis of a positive zero crossing of the magnetic field strength course of the third magnetic field component Bz, the relevant course being reproduced in this context by the current magnetic field data 250 obtained with the aid of all the magnetic field sensors 130. With the aid of the zero-crossing, a boundary 190 of two adjacent permanent magnet pairs and magnet groups 150, and as a result the sensor position of the sensor device with respect to the boundary 190 may be detected.

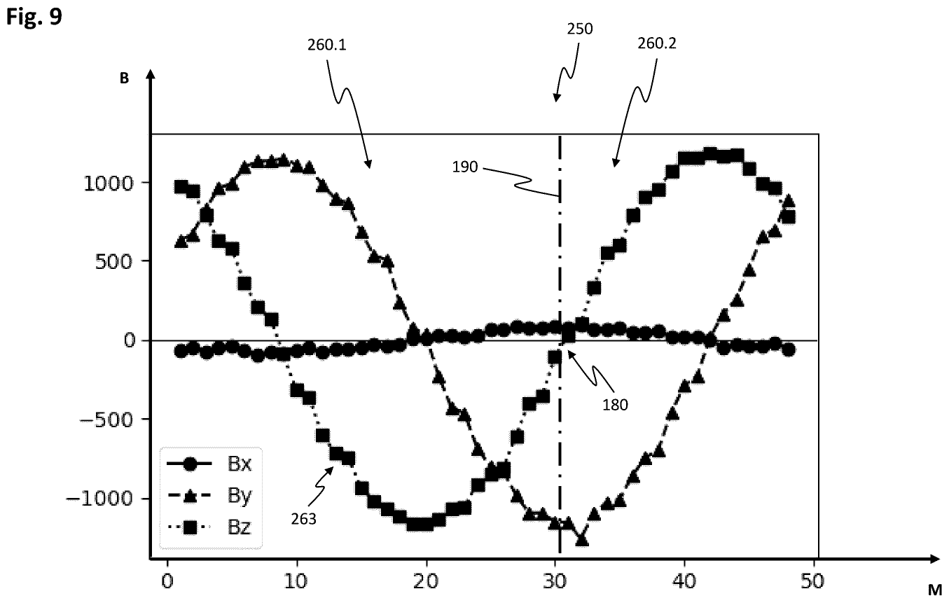

For the purpose of illustration, FIG. 9 shows a diagram of the current magnetic field data 250 as may be provided in the sensor position of the sensor device 120 illustrated in FIG. 8 by detecting the magnetic field of the magnet arrangement 142 with the aid of the magnetic field sensors 130. A course 263 of the magnetic field strength of the third magnetic field component Bz reproduced by the current magnetic field data 250 comprises a positive zero crossing 180, which coincides with the boundary 190 of two adjacent magnet groups 150 (according to FIG. 8 the first and second magnet groups 150.1, 150.2). In this way, the sensor position of the sensor device 120 with respect to the boundary 190, and thereby the offset positioning of the sensor device 120 over two adjacent magnet groups 150, may be detected as well as determined.

Within the framework of determining the sensor position, the distance between the relevant boundary 190 and the magnetic field sensors 130 of the sensor device 120 arranged closest to the boundary 190 in the current position of the primary part 110 may furthermore be determined with reference to the direction of movement 170. For this purpose, the magnetic field sensors 130 arranged closest to the boundary 190 and on both sides of the boundary 190 may first be identified on the basis of the course 263 of the third magnetic field component Bz reproduced by the current magnetic field data 250. Consequently, taking into account the distance between the magnetic field sensors 130 in question and by carrying out interpolation or extrapolation using the course 263, the distance between the boundary 190 and the magnetic field sensors 130 located closest to the boundary 190 may be inferred. With reference to FIGS. 8 and 9, these are the thirtieth magnetic field sensor 130.30 and the thirty-first magnetic field sensor 130, the thirtieth magnetic field sensor 130.30 having the smallest distance to the boundary 190 in the present case.

For the aforementioned step, for example, an equidistant arrangement of the magnetic field sensors 130 with respect to the direction of movement 170 may be taken as a basis, and in this respect the step may be carried out using a (known) uniform distance between the magnetic field sensors 130. As an alternative, however, a non-equidistant arrangement of the magnetic field sensors 130 may be provided, as well, wherein the respective associated individual distance of the magnetic field sensors 130 may be used for the aforementioned step.

A determination of the distance between the magnetic field sensors 130 of the sensor device 120 related to the direction of movement 170 may be carried out in the following manner. For this purpose, a total distance between the end-side magnetic field sensors 130 of the sensor device 120 (according to FIG. 8 between the first and forty-eighth magnetic field sensors 130.1, 130.48) related to the direction of movement 170 may be provided. This may be carried out, for example, by measuring the sensor device 120. Furthermore, phase shifts of courses of a magnetic field component of the magnetic field of the magnet arrangement 142 of the secondary part 140 detected with the aid of the magnetic field sensors 130 may in each case be determined. This may be carried out as part of the initial measurement during movement of the primary part 110 along the secondary part 140.

The magnetic field component used may again be the third magnetic field component Bz. The distances from adjacent magnetic field sensors 130 based on the direction of movement 170 may be determined based on the total distance of the magnetic field sensors 130 and the phase shifts. Based on this or using the respective associated distance (according to FIG. 8 between the thirtieth magnetic field sensor 130.30 and the thirty-first magnetic field sensor 130), the distance between the boundary 190 and the magnetic field sensors 130 located closest to the boundary 190 may be determined.

Based on the determined offset sensor position of the sensor device 120 with respect to a boundary 190 of two adjacent magnet groups 150, it may be furthermore determined to what extent or ratio the sensor device 120 partially overlaps the respective magnet groups 150 in the current position of the primary part 110. From this, it may be deduced by which part of the magnetic field sensors 130 or by which sensor subgroup 240 the two magnet groups 150 are respectively overlapped. In a corresponding manner, it may be determined which part of the current magnetic field data 250 relating to each magnetic group 150 was obtained using which sensor subgroup 240. With reference to FIGS. 8 and 9, the first sensor subgroup 240.1 relating to the partial overlap of one of the two magnet groups 150 (presently the first magnet group 150.1) and the second sensor subgroup 240.2 relating to the partial overlap of the other of the two magnet groups 150 (presently the second magnet group 150.2) may be determined.

Determining the position or carrying out the comparison may be carried out using this information as described below. According to the figures described below, a partial data set of the current magnetic field data 250 for the following description is indicated by the reference sign 260, and partial patterns of the magnetic field patterns 210 are indicated by the reference sign 220.

In a variant of the method, a partial data set 260 is formed from the current magnetic field data 250 on the basis of the offset sensor position of the sensor device 120, which was obtained with the aid of a sensor subgroup 240 from magnetic field sensors 130 of the sensor device 120, with the aid of which the partial overlap of one of the two magnet groups 150 is produced. Corresponding to this, partial patterns 220 are formed from the magnetic field patterns 210 of the reference magnetic field data 200, which take into account the partial overlap of the respective magnet group 150 brought about by the sensor subgroup 240, and may thereby reproduce or replicate the partial overlap with respect to each of the magnet groups 150 of the magnet arrangement 142 associated with the magnetic field patterns 210.

In the similarity comparison, the partial data set 260 of the current magnetic field data 250 is compared to the partial patterns 220 of the magnetic field patterns 210. In this way, a partial pattern 220 and, consequently, a magnetic field pattern 210 with the greatest similarity may be determined, thereby identifying the associated magnet group 150 and, to that extent, the positioning of the sensor device 120 at the relevant magnet group 150. This information, together with the detected sensor position of the sensor device 120 with respect to the boundary 190 of the adjacent magnet groups 150, provides the current position of the primary part 110. Provided that in the sensor position of the sensor device 120 in the current position of the primary part 110, the neighboring magnet groups 150 Are overlapped by the sensor device 120 to a different degree, the forming of the partial data set 260, the partial patterns 220, and the comparison with reference to the larger partial overlap and larger sensor subgroup 240 may be carried out from magnetic field sensors 130.

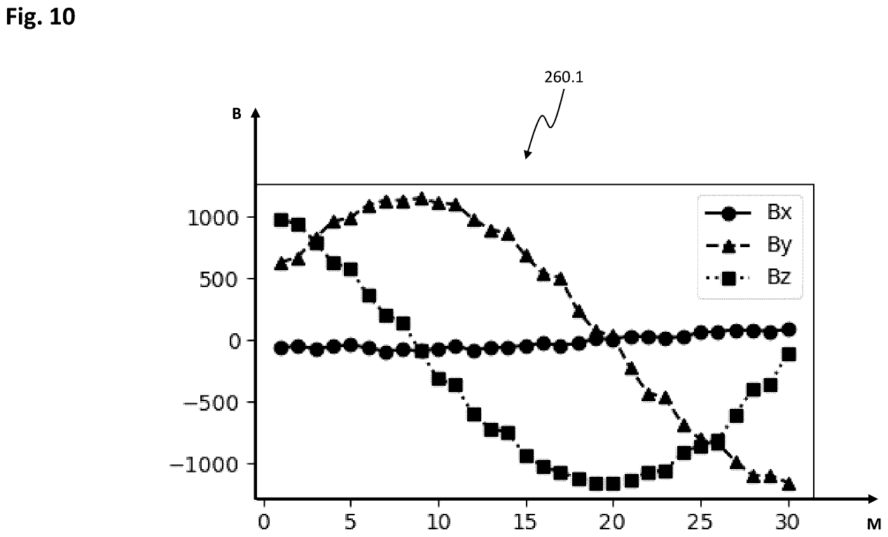

With regard to the sensor position of the sensor device 120 illustrated in FIG. 8 and present in the current position of the primary part 110, the larger partial overlap of one of two adjacent magnet groups 150 by the first sensor subgroup 240.1 (in the present case overlapping the first magnet group 150.1) with respect to the direction of movement 170 takes place. This may be determined on the basis of the determined sensor position. An associated first partial data set 260.1 may thus be formed from those data or data points of the current magnetic field data 250 which were obtained by detecting the magnetic field of the magnet arrangement 142 with the aid of the magnetic field sensors 130 of the first sensor subgroup 240.1 (with the first magnetic field sensor 130.1 up to the thirtieth magnetic field sensor 130.30). According to the diagram of FIG. 9, the first partial data set 260.1 refers to the data points located to the left of the zero crossing 180 and thus the boundary 190. In FIG. 10, the first partial data set 260.1 is shown separately in a separate diagram. The first partial data set 260.1 comprises, corresponding to the thirty magnetic field sensors 130 of the first sensor subgroup 240.1, thirty data points per magnetic field component Bx, By, Bz.

The partial patterns 220 provided for comparison with the first partial data set 260.1 may be formed from the magnetic field patterns 210 of the reference magnetic field data 200, this being done in coordination with the determined partial overlap of a magnetic group 150 by the first sensor subgroup 240.1. In this context, FIG. 8 schematically illustrates a formation of the first partial patterns 220.1 from the magnetic field patterns 210 relating to the partial overlap by the first sensor subgroup 240.1. For each magnetic field pattern 210, a corresponding first partial pattern 220.1 is formed. The first partial patterns 220.1 replicate the partial overlap caused by the first sensor subgroup 240.1 with respect to each of the magnet groups 150 of the magnet arrangement 142 associated with the magnetic field patterns 210. Corresponding to the thirty magnetic field sensors 130 of the first sensor subgroup 240.1, and to the sensor position of the sensor device 120 with respect to the boundary 190 of the adjacent magnetic groups 150, the first partial patterns 220.1 comprise, per magnetic field component Bx, By, Bz, respectively the last thirty data points of the magnetic field patterns 210.

In the subsequent similarity comparison, according to FIG. 7, the first partial data set 260.1 of the current magnetic field data 250 may be compared to each first partial pattern 220.1 of the magnetic field patterns 210 (i.e., the first partial pattern 220.1 of the first magnetic field pattern 210.1, the first partial pattern 220.1 of the second magnetic field pattern 210.2, . . . the first partial pattern 220.1 of the nth magnetic field pattern 210.n) to respectively determine a corresponding distance measure 270 (i.e. a first distance measure 270.1, a second distance measure 270.2, . . . a nth distance measure 270.n). Through this, the first partial pattern 220.1 and the corresponding magnetic field pattern 210 with the highest similarity, i.e. for which the smallest distance dimension 270 is present, and consequently the positioning of the sensor device 120 at the associated magnet group 150 may be determined. With reference to FIG. 8, this is the first magnet group 150.1. Together with the detected offset sensor position of the sensor device 120 with respect to the boundary 190 of the associated magnet groups 150 (in this case the magnet groups 150.1, 150.2), this information reflects the current position of the primary part 110 on the secondary part 140.

In a corresponding manner, it is possible to carry out the formation of the partial data set 260, the partial pattern 220 and the comparison with respect to the other of the two partial overlaps of the adjacent magnet groups 150. With respect to FIG. 8, this is the smaller partial overlap realized by the second sensor subgroup 240.2. Here, an associated second partial data set 260.2 may be formed from the data points of the current magnetic field data 250 obtained by detecting the magnetic field of the magnet arrangement 142 using the magnetic field sensors 130 of the second sensor partial group 240.2 (with the thirty-first to the forty-eighth magnetic field sensors 130.48).

According to the diagram of FIG. 9, the second partial data set 260.2 comprises the data points located to the right of the zero crossing 180 and thus of the boundary 190, the number of which, corresponding to the second sensor subgroup 240.2, is eighteen per magnetic field component Bx, By, Bz. Furthermore, second partial patterns 220.2 may be formed from the magnetic field patterns 210 which replicate the partial overlap effected by the second sensor subgroup 240.2 with respect to each of the magnet groups 150 of the magnet arrangement 142 associated with the magnetic field patterns 210, as schematically indicated in FIG. 8. Corresponding to the eighteen magnetic field sensors 130 of the second sensor subgroup 240.2 and the sensor position of the sensor device 120 with respect to the boundary 190, the second partial patterns 220.2 each comprise the first eighteen data points of the magnetic field patterns 210 per magnetic field component Bx, By, Bz.

In the similarity comparison, corresponding to FIG. 7, the second partial data set 260.2 of the current magnetic field data 250 may be compared to each second partial pattern 220.2 of the magnetic field patterns 210 to obtain a corresponding distance measure 270 in each case. In this way, the second partial pattern 220.2 and the corresponding magnetic field pattern 210 with the greatest similarity, and thereby the positioning of the sensor device 120 at the associated magnet group 150 (i.e., the second magnet group 150.2 in FIG. 8), may be determined. Together with the detected offset sensor position of the sensor device 120 with respect to the boundary 190 of the associated magnet groups 150 (in this case, the magnet groups 150.1, 150.2), this information provides the current position of the primary part 110 on the secondary part 140.

In the event that, in the current position of the primary part 110, the adjacent groups of magnets 150 are (substantially) equally overlapped by the sensing device 120, in a manner different from FIG. 8, carrying out the comparison may be done using a partial data set 260 of the current magnetic field data 250 and partial patterns 220 of the magnetic field patterns 210 with respect to one of the two partial overlaps.

Regardless of the degree of the respective overlapping, it is further possible to form a respective partial data set 260 and corresponding partial patterns 220 with respect to both partial overlaps, and to compare the respective partial data set 260 with the corresponding partial patterns 220. For each partial data set 260, a corresponding partial pattern 220 and a magnetic field pattern 210 with the greatest similarity, and thereby an associated magnetic group 150, may thereby be determined. Furthermore, a plausibility check may be realized in this way. This is because with reference to the determined partial patterns 220 with the greatest similarity, it is required that these belong to two adjacent magnet groups 150. If this is not the case, an error, for example in the form of incorrect data, may be concluded on the basis of this plausibility check.

With respect to FIGS. 8 and 9, the first partial data set 260.1 may be compared to each of the first partial patterns 220.1, and the second partial data set 260.2 may be compared to each of the second partial patterns 220.2. Based on the comparison or the greatest similarity determined, an associated magnet group 150 may be determined in each case. For the sensor position shown in FIG. 8, this should be the first and second magnet group 150.1, 150.2. If this is not the case and, for example, the first magnet group 150.1 is determined during the comparison carried out with the first partial data set 260.1, and another magnet group 150 is determined instead of the second magnet group 150.2 during the comparison carried out with the second partial data set 260.2, an error may be detected.

With regard to the above-mentioned case that the magnetic field sensors 130 of the sensor device 120 in the current position of the primary part 110 are located in the area of a magnet group 150 of the magnet arrangement 142 of the secondary part 140 and thereby, for example, a situation as shown in FIG. 4 occurs, such a positioning may also be detected by determining the sensor position of the sensor device 120 with respect to a boundary 190 of two adjacent pairs of permanent magnets or magnet groups 150. The boundary 190 in question may in this case be provided in the region of an edge or end of the sensor device 120. In FIG. 4, for example, this is the boundary 190 indicated by the dashed line at the left end of the sensor device 120.

Such a sensor position may be determined based on a presence of a positive zero-crossing coinciding with the boundary 190 in a magnetic field strength course of the third magnetic field component Bz, which may be reflected by the current magnetic field data 250 obtained using all of the magnetic field sensors 130. Insofar as no positive zero crossing is present in the magnetic field strength course or in the region of the ends of the magnetic field strength course, it may be detected that the magnetic field sensors 130 of the sensor device 120 are located in the region of a magnetic group 150 in the current position of the primary part 110 and the relevant magnetic group 150 is overlapped by the magnetic field sensors 130. In this case, in order to determine the position of the primary part 110, the current magnetic field data 250 may be compared to the magnetic field patterns 210 of the reference magnetic field data 200 and, as described above with reference to FIG. 7, a magnetic field pattern 210 with the greatest similarity, and thus the associated magnet group 150 and to that extent the positioning of the sensor device 120 at the relevant magnet group 150, may be determined.

For determining the position, the distance between a boundary 190 and a magnetic field sensor 130 arranged closest to the boundary 190 may also be determined in relation to the direction of movement 170. With reference to FIG. 4, this is for example the first magnetic field sensor 130.1. The relevant distance may be determined by carrying out an extrapolation using the magnetic field strength course of the third magnetic field component Bz reproduced by the current magnetic field data 250. This distance information relating to the sensor position, together with the determined positioning of the sensor device 120 on a magnet arrangement 150, may reflect the current position of the primary part 110 on the secondary part 140.

With a detected sensor position of the sensor device 120 in the area of two adjacent magnet groups 150 in the current position of the primary part 110, wherein both magnet groups 150 are each partially overlapped by the sensor device 120, as illustrated in FIG. 8, the following procedure may also be used to determine the position.

In a further variant of the method, newly composed magnetic field patterns are formed, which are in each case composed taking into account the partial overlaps, from partial patterns 220 of magnetic field patterns 210 of two adjacent magnet groups 150 provided in the course of the initial measurement. In this case, the newly composed magnetic field patterns may reproduce or replicate the positioning of the sensor device 120 determined on the basis of the sensor position, and thus the overlap caused by the sensor device 120, in each case with respect to two adjacent magnet groups 150 of the magnet arrangement 142. In the similarity comparison, the current magnetic field data 250 is compared to the composed magnetic field patterns.

In this way, a composed magnetic field pattern with the greatest similarity, thereby the two magnet groups 150 belonging to the composed magnetic field pattern, and to that extent the positioning of the sensor device 120 at the two magnet groups 150 in question, may be determined. This information, together with the detected sensor position of the sensor device 120 with respect to the boundary 190 of the adjacent magnet groups 150, provides the current position of the primary part 110.

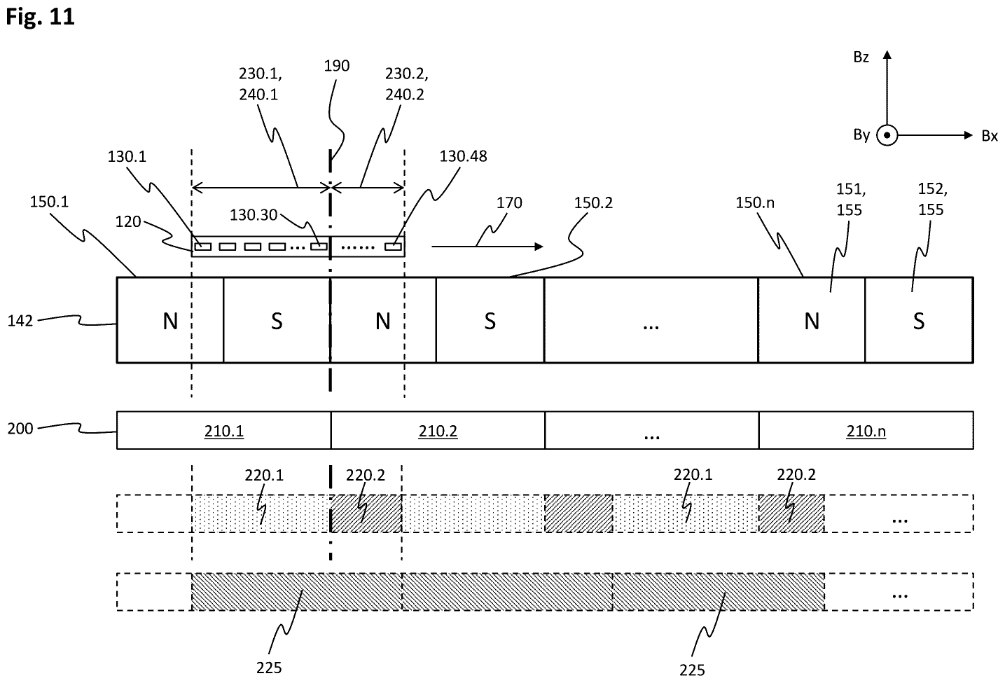

By way of illustration, FIG. 11 shows a further embodiment in which the sensor device 120 is arranged at an offset in the region of two adjacent magnet groups 150 or the first and second magnet groups 150.1, 150.2, as shown in FIG. 8. The first magnet group 150.1 is overlapped, with respect to the direction of movement 170, by the first sensor subgroup 240.1 comprising thirty magnetic field sensors 130. The second magnet group 150.2 is overlapped, with respect to the direction of movement 170, by the second sensor subgroup 240.2 comprising eighteen magnetic field sensors 130.

FIG. 11 further schematically illustrates a formation of newly composed magnetic field patterns 225, which reproduce the overlap realized by the sensor device 120 respectively with respect to two adjacent magnet groups 150 of the magnet arrangement 142 and their magnetic field patterns 210. The composed magnetic field patterns 225 each comprise a first partial pattern 220.1 of a magnetic field pattern 210 of a magnet group 150 and a second partial pattern 220.2 of a magnetic field pattern 210 of a magnet group 150 adjacent thereto. Via a first partial pattern 220.1, the partial overlap effected by the first sensor subgroup 240.1 is reproduced in each case with respect to a magnet group 150, and via a second partial pattern 220.2, the partial overlap effected by the second sensor subgroup 240.2 is reproduced in each case with respect to a magnet group 150 adjacent thereto.

For example, as is evident from FIG. 11 with reference to the first and second magnetic field patterns 210.1, 210.2 of the reference magnetic field data 200, one of the composed magnetic field patterns 225 is formed using a first partial pattern 220.1 of the first magnetic field pattern 210.1 and a second partial pattern 220.2 of the second magnetic field pattern 210.2. Similarly, forming a further composed magnetic field pattern 225 using a first partial pattern 220.1 of the second magnetic field pattern 210.2 and a second partial pattern 220.2 of a third magnetic field pattern 210. The formation of further composed magnetic field patterns 225 may be continued in an analogous manner until the nth magnetic field pattern 210.n is formed.

Corresponding to the thirty magnetic field sensors 130 of the first sensor subgroup 240.1 and to the sensor position of the sensor device 120 with respect to the boundary 190 of the neighboring magnetic groups 150, the first partial patterns 220.1 per magnetic field component Bx, By, Bz each comprise the last thirty data points of the magnetic field patterns 210. Corresponding to the eighteen magnetic field sensors 130 of the second sensor subgroup 240.2 and to the sensor position of the sensor device 120 with respect to the boundary 190 of the neighboring magnetic groups 150, the second partial patterns 220.2 each comprise the first eighteen data points of the magnetic field patterns 210 per magnetic field component Bx, By, Bz. The composed magnetic field patterns 225 thereby comprise, corresponding to the current magnetic field data 250, forty-eight data points for each magnetic field component Bx, By, Bz.

In the similarity comparison, as shown in FIG. 7, the current magnetic field data 250 may be compared to each of the composed magnetic field patterns 225 to obtain a corresponding distance measure 270 for each. Through this, a composed magnetic field pattern 225 with the greatest similarity, i.e., which has the smallest distance dimension 270, and consequently the positioning of the sensor device 120 at the associated two groups of magnets 150 may be determined. Together with the detected offset sensor position of the sensor device 120 with respect to the boundary 190 of the associated magnet groups 150 (in this case the magnet groups 150.1, 150.2), this information provides the current position of the primary part 110 on the secondary part 140.

With a detected sensor position of the sensor device 120 in the area of two adjacent magnet groups 150 in the current position of the primary part 110, with the consequence that both magnet groups 150 are each partially overlapped by the sensor device 120, the position determination may further be carried out as follows.

In a further variant of the method, a predetermined division of the magnetic field sensors 130 of the sensor device 120 into a plurality of (i.e. at least two) sensor subgroups 240 is taken as a basis. The division is independent of the sensor position of the sensor device 120 in the current position of the primary part 110. The division may be carried out in such a way that the sensor subgroups 240 each comprise the same number of magnetic field sensors 130. According to the division of the magnetic field sensors 130, the current magnetic field data 250 is divided up into a plurality (i.e., at least two) of partial data sets 260 obtained from magnetic field sensors 130 using the individual sensor subgroups 240 each partially overlapping the magnet arrangement 142.

Furthermore, partial patterns 220 are formed from the magnetic field patterns 210 of the reference magnetic field data 200, which is carried out by taking into account the detected sensor position of the sensor device 120 in the current position of the primary part 110, as well as by taking into account the division of the magnetic field sensors 130 and thus the partial overlaps caused by the sensor subgroups 240. The sensing of the sensor position, in which the position of the sensor device 120 with respect to a boundary 190 of adjacent magnetic groups 150 is determined, may be carried out as described above on the basis of a positive zero crossing of the magnetic field strength course of the third magnetic field component Bz, which is reproduced by the current magnetic field data 250.

The partial patterns 220 used in this method variant may reproduce or replicate the partial overlaps caused by the individual sensor subgroups 240, respectively, with respect to two adjacent magnet groups 150 of the magnet arrangement 142. In the event that a sensor subgroup 240 overlaps the boundary 190 of the adjacent magnet groups 150, which may be detected based on the detected sensor position, those partial patterns 220 which reproduce the partial overlap brought about by this sensor subgroup 240 may be formed, similar to the previously described method variant, by combining corresponding parts of magnetic field patterns 210 of adjacent magnet groups 150. Depending on the particular division of the magnetic field sensors 130, it is possible for multiple sensor subgroups 240 to overlap the boundary 190. In this case, too, the partial patterns 220 relating to the partial overlaps of these sensor subgroups 240 may be composed by parts of magnetic field patterns 210 from neighboring magnetic groups 150.

In the similarity comparison, the partial data sets 260 are compared to the respective partial patterns 220 belonging with respect to the sensor position of the sensor device 120 and the distribution of the magnetic field sensors 130 and thus the partial overlaps caused by the sensor subgroups 240. In this way, the partial patterns 220 with the greatest similarity, as a result the two magnet groups 150 belonging to the partial patterns 220, and insofar the positioning of the sensor device 120 at the two magnet groups 150 in question, may be determined. This information, together with the detected sensor position of the sensor device 120 with respect to the boundary 190 of the adjacent magnet groups 150, reflects the current position of the primary part 110.

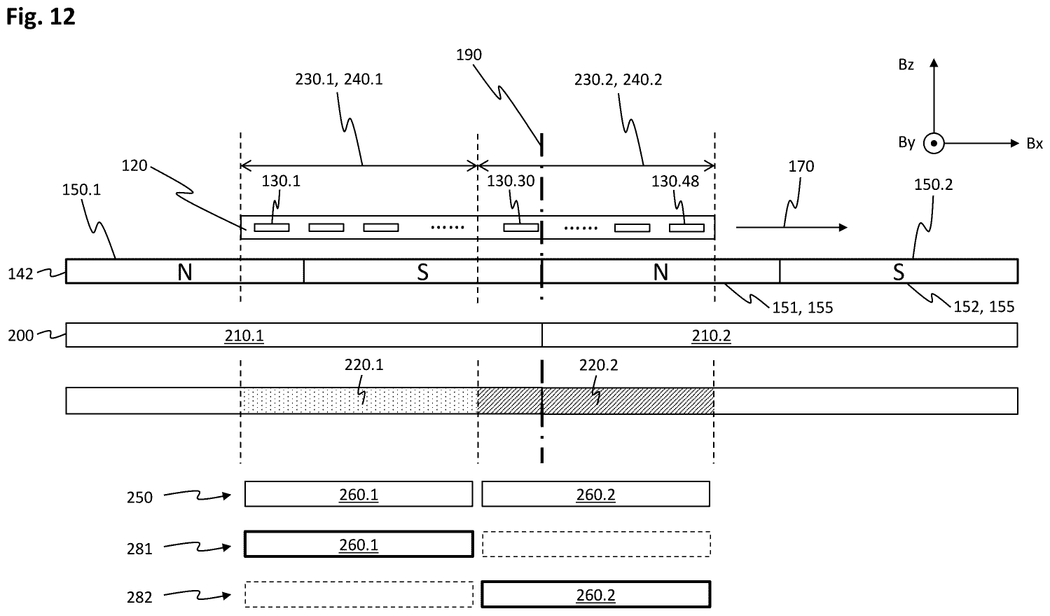

By way of illustration, FIG. 12 shows a further depiction in which the sensor device 120 is arranged at an offset in the current position of the primary part 110 in the region of two adjacent magnet groups 150, in this case again the first and second magnet groups 150.1, 150.2. Here again, the first magnetic group 150.1 is overlapped by thirty magnetic field sensors 130 (with the first magnetic field sensor 130.1 up to the thirtieth magnetic field sensor 130.30), and the second magnetic group 150.2 is overlapped by eighteen magnetic field sensors 130 (with the thirty-first magnetic field sensor 130 up to the forty-eighth magnetic field sensor 130.48) of the sensor device 120.

For the purpose of position determination, a predetermined division of the magnetic field sensors 130 of the sensor device 120 into a plurality of sensor subgroups 240 is used, independently of this. According to the procedure illustrated in FIG. 12, a division into two sensor subgroups 240, i.e. a first and a second sensor subgroup 240.1, 240.2, each comprising twenty-four magnetic field sensors 130, is provided. In this context, the first sensor subgroup 240.1 comprises the first magnetic field sensor 130.1 up to a twenty-fourth magnetic field sensor 130, and the second sensor subgroup 240.2 comprises a twenty-fifth magnetic field sensor 130 up to the forty-eighth magnetic field sensor 130.48 of the sensor device 120. With the aid of the two sensor subgroups 240.1, 240.2, with reference to the direction of movement 170, a different part of the magnet arrangement 142 or of the neighboring magnet groups 150.1, 150.2 is respectively overlapped. Here, there is a first overlapping region 230.1 relating to the partial overlap by the first sensor subgroup 240.1 and a second overlapping region 230.2 relating to the partial overlap by the second sensor subgroup 240.2.

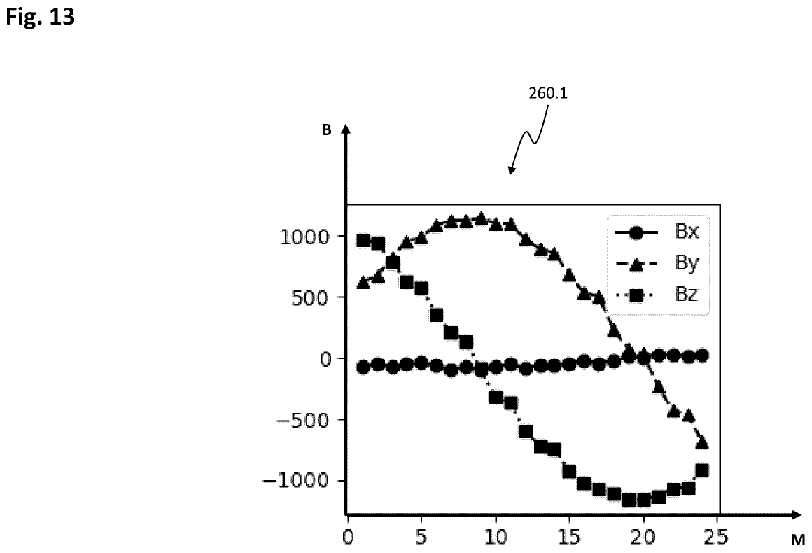

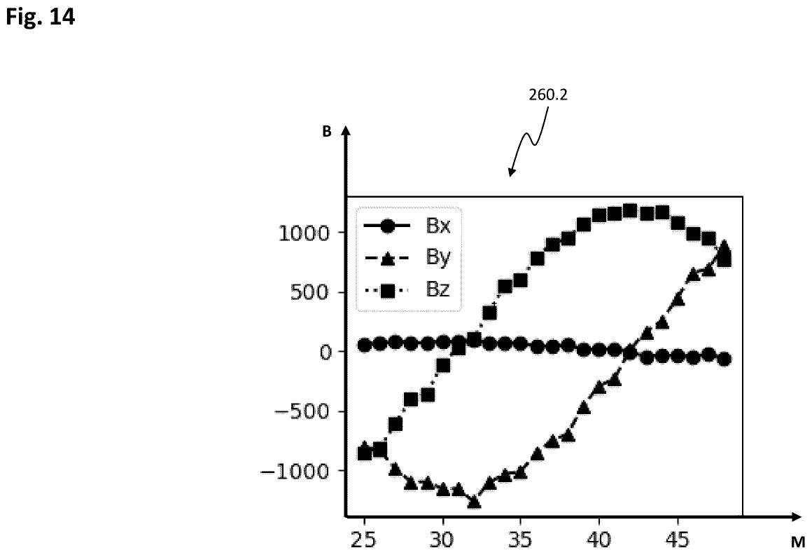

In accordance with the distribution of the magnetic field sensors 130 between the two sensor subgroups 240.1, 240.2, the current magnetic field data 250, as indicated in FIG. 12, may be divided up into a first partial data set 260.1 and a second partial data set 260.2, the first partial data set 260.1 having been obtained by detecting the magnetic field of the magnet arrangement 142 with the aid of the first sensor subgroup 240.1 and the second partial data set 260.2 having been obtained by detecting the magnetic field of the magnet arrangement 142 with the aid of the second sensor subgroup 240.2. The two partial data sets 260.1, 260.2 have, corresponding to the twenty-four magnetic field sensors 130 per sensor subgroup 240.1, 240.2, twenty-four data points per magnetic field component Bx, By, Bz. The partial sets 260.1, 260.2 may comprise data points, as illustrated in the diagrams of FIGS. 13 and 14.

FIG. 12 further schematically illustrates a formation of partial patterns 220 from the magnetic field patterns 210 of the reference magnetic field data 200, which is carried out both in coordination with the detected sensor position of the sensor device 120 with respect to the boundary 190 and in coordination with the partial overlaps effected by the sensor subgroups 240.1, 240.2. Here, first and second partial patterns 220.1, 220.2 are formed which replicate the partial overlaps realized by the first and second sensor subgroups 240.1, 240.2 respectively with respect to two adjacent magnet groups 150 of the magnet arrangement 142 and their magnetic field patterns 210.

Corresponding to the twenty-four magnetic field sensors 130 of the first sensor subgroup 240.1 and to the sensor position of the sensor device 120 with respect to the boundary 190 of the adjacent magnetic groups 150.1, 150.2, the first partial patterns 220.1 each comprise twenty-four data points of the magnetic field patterns 210 associated with the magnetic groups 150 per magnetic field component Bx, By, Bz, each being a nineteenth to a forty-second data point of the magnetic field patterns 210.

Also corresponding to the twenty-four magnetic field sensors 130 of the second sensor subgroup 240.2 and to the sensor position of the sensor device 120 with respect to the boundary 190, the second partial patterns 220.2 each comprise twenty-four data points per magnetic field component Bx, By, Bz. Due to the fact that there is an overlap of the boundary 190 in the second sensor subgroup 240.2, as shown in FIG. 12, which may be recognized on the basis of the sensor position, the associated second partial patterns 220.2, which reflect the partial overlap caused by the second sensor subgroup 240.2, are composed of parts of magnetic field patterns 210 of neighboring magnetic groups 150 matched thereto. The second partial patterns 220.2 therefore comprise six data points per magnetic field component Bx, By, Bz, which are the last six data points of magnetic field patterns 210 associated with the magnetic groups 150, and a further eighteen data points, which are the first eighteen data points of magnetic field patterns 210 of magnetic groups 150 adjacent thereto (and, according to FIG. 12, located to the right thereof).

In FIG. 12, the formation of a first and second partial pattern 220.1, 220.2 is shown only with reference to the first magnetic field pattern 210.1 and the second magnetic field pattern 210.2 of the reference magnetic field data 200. In a corresponding manner, further first and second partial patterns 220.1, 220.2 are formed with reference to the second magnetic field pattern 210.2 and a third magnetic field pattern 210, with reference to the third and a fourth magnetic field pattern 210, etc., up to a nth magnetic field pattern.

In the similarity comparison, as shown in FIG. 7, the partial data sets 260.1, 260.2 of the current magnetic field data 250 may be compared to the respective associated partial patterns 220.1, 220.2 with respect to the sensor position of the sensor device 120 and the partial overlaps caused by the sensor subgroups 240.1, 240.2, in order to obtain a respective corresponding distance measure 270. As indicated in FIG. 12, the first set of partial data 260.1 may be compared to each of the associated first partial patterns 220.1 in a first evaluation 281, and the second set of partial data 260.2 may be compared to each of the associated second partial patterns 220.2 in a second evaluation 282.

In this way, a first and second partial pattern 220.1, 220.2 with the greatest similarity, i.e. in which the smallest distance dimension 270 is provided in each case, may be determined. Accordingly, those two adjacent magnet groups 150, and thereby a positioning of the sensor device 120 may be determined at those adjacent magnet groups 150 which belong to the determined partial patterns 220.1, 220.2. In addition to the detected sensor position of the sensor device 120 with respect to the boundary 190 of the respective magnet groups 150 (in this case, the magnet groups 150.1, 150.2), this information reflects the current position of the primary part 110 on the secondary part 140.

With the aid of the aforementioned method variant, a plausibility check may also be achieved. Here, it is required that two neighboring magnet groups 150 are determined in a matching manner on the basis of the determined partial patterns 220 with the greatest similarity. If this is not the case, the presence of an error, for example in the form of erroneous data, may be assumed. With regard to FIG. 12, such an error may become apparent, for example, by the fact that in the first evaluation 281 the first magnet group 150.1 is identified, and in the second evaluation 282 other magnet groups 150 are determined instead of the first and second magnet groups 150.1, 150.2.

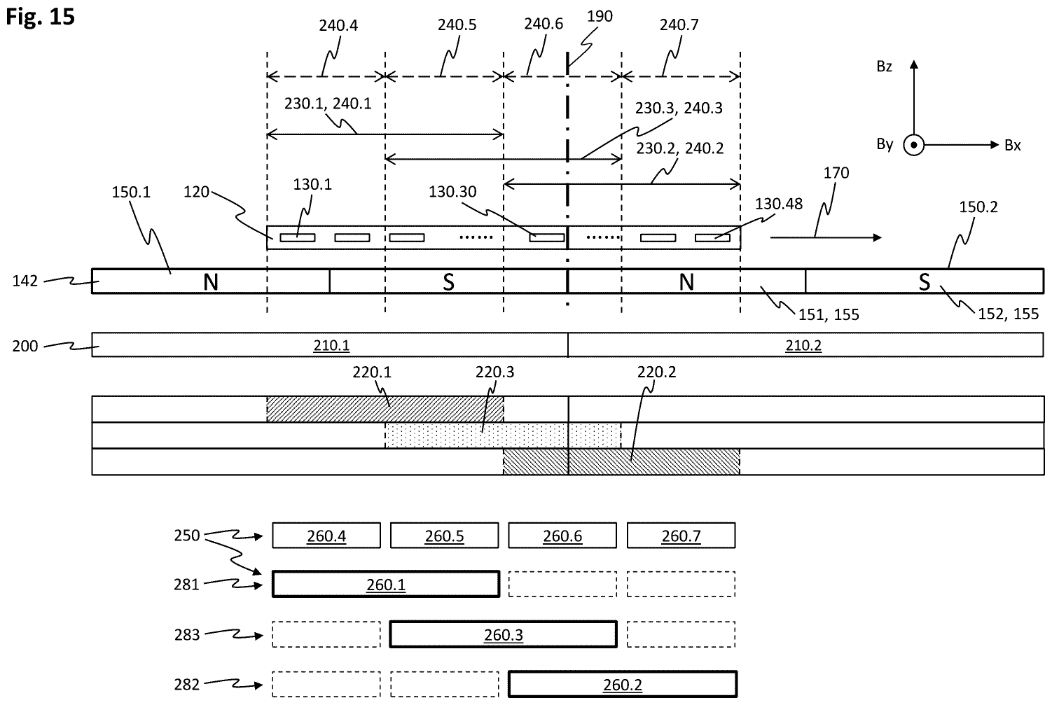

Deviating from the procedure described on the basis of FIG. 12, other distributions of the magnetic field sensors 130 of the sensor device 120 may also be considered. For illustration purposes, FIG. 15 shows a further depiction of the sensor device 120, which is arranged at an offset in the current position of the primary part 110 in the region of two adjacent magnet groups 150 or the first and second magnet groups 150.1, 150.2. Here, too, the first magnet group 150.1 is overlapped by thirty magnetic field sensors 130 and the second magnet group 150.2 is overlapped by eighteen magnetic field sensors 130 of the sensor device 120.

As shown in FIG. 15, the magnetic field sensors 130 may be divided up into four sensor partial sets 240, i.e., a fourth, fifth, sixth and seventh sensor partial set 240.4, 240.5, 240.6, 240.7, each comprising twelve magnetic field sensors 130. Corresponding to this, the current magnetic field data 250 may be divided up into four partial data sets 260, i.e. a fourth, fifth, sixth and seventh partial data set 260.4, 260.5, 260.6, 260.7, which each have twelve data points per magnetic field component Bx, By, Bz. Coordinated with the detected sensor position of the sensor device 120 with respect to the boundary 190 and coordinated with the partial overlaps effected by the sensor subgroups 240.4, 240.5, 240.6, 240.7, furthermore partial patterns 220 may be formed from the magnetic field patterns 210 of the reference magnetic field data 200, which contain the partial data components formed by the sensor subgroups 240.4, 240.5, 240.6, 240.7, respectively, with respect to two adjacent magnet groups 150 of the magnet arrangement 142 and their magnetic field patterns 210, and which comprise twelve data points per magnetic field component Bx, By, Bz, respectively.

By carrying out the similarity comparison, in which the partial data sets 260.4, 260.5, 260.6, 260.7 of the current magnetic field data 250 are compared to the respective associated partial patterns 220 with respect to the sensor position and the distribution of the magnetic field sensors 130 to the sensor subgroups 240.4, 240.5, 240.6, 240.7, four partial patterns 220 with the greatest similarity, thus the associated two magnetic groups 150, and thereby the positioning of the sensor device 120 at the respective two magnetic groups 150, may be determined. This information, together with the sensor position of the sensor device 120, indicates the current position of the primary part 110 on the secondary part 140. If different neighboring magnet groups 150 are determined, it may be concluded that a fault is present.

FIG. 15 further illustrates a further variant in which the magnetic field sensors 130 of the sensor device are divided into three partially overlapping sensor subgroups 240, i.e. a first, second and third sensor subgroup 240.1, 240.2, 240.3, each comprising twenty-four magnetic field sensors 130. In this regard, the first and second sensor subgroups 240.1, 240.2 correspond to the sensor subgroups 240 of FIG. 12. The third sensor subgroup 240.3 overlaps with the other two sensor subgroups 240.1, 240.2 and is composed of half of the magnetic field sensors 130 of each of the other two sensor subgroups 240.1, 240.2. By the three sensor subgroups 240.1, 240.2, 240.3, with reference to the direction of movement 170, a different part of the magnet arrangement 142 or of the adjacent magnet groups 150.1, 150.2 is overlapped in each case. In a corresponding manner, three overlapping regions 230, i.e. a first overlapping region 230.1, a second overlapping region 230.2 and a third overlapping region 230.3, relating to the partial overlaps by the three sensor subgroups 240.1, 240.2, 240.3 are present.

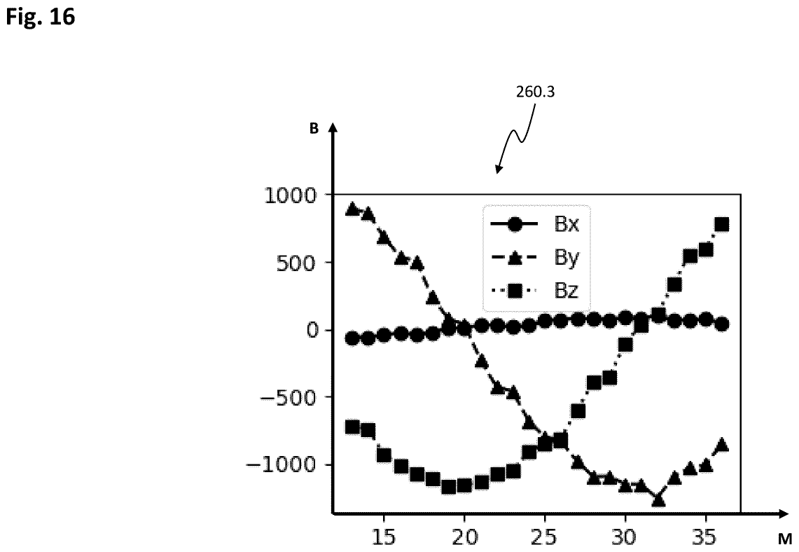

According to the division of the magnetic field sensors 130, the current magnetic field data 250, as shown in FIG. 15, may be divided up into three overlapping partial data sets 260, i.e., a first, second and third partial data set 260.1, 260.2, 260.3, each obtained by detecting the magnetic field of the magnet arrangement 142 using one of the three sensor subgroups 240.1, 240.2, 240.3. The three partial data sets 260.1, 260.2, 260.3 have, corresponding to the twenty-four magnetic field sensors 130 per sensor subgroup 240.1, 240.2, 240.3, twenty-four data points per magnetic field component Bx, By, Bz. The first and second partial sets of data 260.1, 260.2 may comprise data points as shown in the diagrams of FIGS. 13 and 14. With reference to the data points of the third partial set 260.3, the diagram of FIG. 16 may be applied.

The first, second, and third sensor subgroups 240.1, 240.2, 240.3 may emerge based on the previously described division with the four sensor subgroups 240.4, 240.5, 240.6, 240.7 in that the first sensor subgroup 240.1 comprises the fourth and fifth sensor subgroups 240.4, 240.5, the second sensor subgroup 240.2 comprises the sixth and seventh sensor subgroups 240.6, 240.7, and the third sensor subgroup 240.3 comprises the fifth and sixth sensor subgroups 240.5, 240.6. In a corresponding manner, the first, second, and third partial data sets 260.1, 260.2, 260.3 may be formed by using the four partial data sets 260.4, 260.5, 260.6, 260.7, wherein the first partial data set 260.1 comprises the fourth and fifth partial data sets 260.4, 260.5, the second partial data set 260.2 comprises the sixth and seventh partial data sets 260.6, 260.7, and the third partial data set 260.3 comprises the fifth and sixth partial data sets 260.5, 260.6.

FIG. 15 further schematically illustrates a formation of partial patterns 220 from the magnetic field patterns 210 of the reference magnetic field data 200, which is carried out taking into account the sensor position of the sensor device 120 with respect to the boundary 190 and taking into account the partial overlaps realized by the three sensor subgroups 240.1, 240.2, 240.3. In this context, first, second and third partial patterns 220.1, 220.2, 220.3 are formed which reflect the partial overlaps realized by the three sensor subgroups 240.1, 240.2, 240.3 respectively with respect to two adjacent magnet groups 150 of the magnet arrangement 142 and their magnetic field patterns 210.

Corresponding to the twenty-four magnetic field sensors 130 of the first sensor subgroup 240.1 and to the sensor position of the sensor device 120 with respect to the boundary 190 of the adjacent magnetic groups 150.1, 150.2, the first partial patterns 220.1 each comprise twenty-four data points, i.e., a nineteenth to a forty-second data point, of the magnetic field patterns 210 of the magnetic groups 150 per magnetic field component Bx, By, Bz.

Also corresponding to the twenty-four magnetic field sensors 130 of the second sensor subgroup 240.2 and to the sensor position of the sensor device 120 with respect to the boundary 190, the second partial patterns 220.2 each comprise twenty-four data points per magnetic field component Bx, By, Bz. As shown in FIG. 15, the second sensor partial pattern 240.2 overlaps the boundary 190, which may be detected based on the sensor position. Consequently, the second partial patterns 220.2, which reflect the partial overlap caused by the second sensor subgroup 240.2, are composed of parts of magnetic field patterns 210 of neighboring magnetic groups 150 matched thereto. For each magnetic field component Bx, By, Bz, the second partial patterns 220.2 therefore comprise six first data points, which are the last six data points of magnetic field patterns 210 of magnet groups 150, and a further eighteen data points, which are the first eighteen data points of magnetic field patterns 210 of magnet groups 150 adjacent thereto (and, according to FIG. 15, located to the right thereof).

In an analogous manner and corresponding to the twenty-four magnetic field sensors 130 of the third sensor subgroup 240.3 and to the sensor position of the sensor device 120 with respect to the boundary 190, the third partial patterns 220.3 each comprise twenty-four data points per magnetic field component Bx, By, Bz. Due to the fact that there is also an overlap of the boundary 190 in the case of the third sensor subgroup 240.3, as shown in FIG. 15, which may be recognized on the basis of the sensor position, the third partial patterns 220.3, which reproduce the partial overlap brought about by the third sensor subgroup 240.3, are composed of parts of magnetic field patterns 210 of neighboring magnet groups 150 which are matched thereto. Therefore, in the present case, the third partial patterns 220.3 comprise eighteen data points per magnetic field component Bx, By, Bz, which are the last eighteen data points of magnetic field patterns 210 of magnet groups 150, and further six data points, which are the first six data points of magnetic field patterns 210 of magnet groups 150 adjacent thereto (and located to the right thereof according to FIG. 15).

In FIG. 15, the formation of a first, second and third partial pattern 220.1, 220.2, 220.3 is shown only with reference to the first magnetic field pattern 210.1 and the second magnetic field pattern 210.2 of the reference magnetic field data 200. In a corresponding manner, further first, second and third partial patterns 220.1, 220.2, 220.3 are formed with reference to the second magnetic field pattern 210.2 and a third magnetic field pattern 210, with reference to the third and a fourth magnetic field pattern 210, etc., up to a nth magnetic field pattern.

In the similarity comparison, as shown in FIG. 7, the partial data sets 260.1, 260.2, 260.3 of the current magnetic field data 250 may be compared to the respective associated partial patterns 220.1, 220.2, 220.3 with respect to the sensor position of the sensor device 120 and the distribution of the magnetic field sensors 130 to the sensor subgroups 240.1, 240.2, 240.3, in order to obtain a respective corresponding distance measure 270.

As indicated in FIG. 15, in a first evaluation 281, the first partial data set 260.1 may be compared to each of the associated first partial patterns 220.1, in a second evaluation 282, the second partial data set 260.2 may be compared to each of the associated second partial patterns 220.2, and in a third evaluation 283, the third partial data set 260.3 may be compared to each of the associated third partial patterns 220.3. By this, three partial patterns 220.1, 220.2, 220.3 with the greatest similarity, thus the associated two magnet groups 150, and thereby the positioning of the sensor device 120 at the respective two magnet groups 150 (presently the magnet groups 150.1, 150.2), may be determined. This information, together with the sensor position of the sensor device 120, indicates the current position of the primary part 110 on the secondary part 140. If different adjacent magnet groups 150 are determined, a fault may be detected.

With the aid of the aforementioned method variants, the position of the primary part 110 with respect to the secondary part 140 may be determined with a high degree of reliability and accuracy. To favor reliability and accuracy, it is further possible to carry out a plurality of the method variants. For example, the procedure described with reference to FIG. 8, in which the similarity comparison is carried out on the basis of a partial overlap of a magnet group 150 determined on the basis of the sensor position of the sensor device 120, may be combined with the procedure described with reference to FIG. 12 or 15, in which the similarity comparison is carried out on the basis of a division of the magnetic field sensors 130 of the sensor device 120 into sensor subgroups 240. Hereby, a further plausibility check may be realized.

It is further noted that the above numerical data, such as the number of magnetic field sensors 130 of the sensor device 120, are to be considered as examples only, which may be replaced or implemented by other numerical data.

The sensor device 120, whose magnetic field sensors 130 may overlap a magnet group 150 comprising a pair of two permanent magnets 155 or a first and second permanent magnet 151, 152 as indicated above, may therefore have a different or larger number of magnetic field sensors 130 distributed along the direction of movement 170 and arranged in spaced relation to one another on the circuit board 121 of the sensor device 120. For example, seventy-two or even more magnetic field sensors 130 are possible. In this way, the accuracy and reliability of the position determination may be favored. This may be noticeable, for example, with respect to an embodiment of the magnet arrangement 142 of the secondary part 140 having a relatively large number of permanent magnets 155 and pairs of permanent magnets.

However, a maximum possible number of magnetic field sensors 130 may be limited by mutual interference between the magnetic field sensors 130, which may occur when the magnetic field sensors 130 are relatively small distances apart. In this context, it is possible to design the sensor device 120 in terms of dimensions in such a way that a larger number of pairs of permanent magnets may be overlapped with the aid of the magnetic field sensors 130. In this way, an embodiment of the sensor device 120 with a relatively large number of magnetic field sensors 130 may be used. Further, the magnetic field sensors 130 may be spaced apart from each other such that interference between the magnetic field sensors 130 may be avoided.

The position may be determined here on the basis of magnet groups 150, which comprise not one permanent magnet pair but, matched to the sensor device 120 and corresponding to the possible overlapping by the magnetic field sensors 130, a plurality of permanent magnet pairs each comprising a first and second permanent magnet 151, 152. Also, the distribution of the permanent magnets 155 among the magnet groups 150 may be realized in such a way that the magnet groups 150 partially overlap.

In this context, it is further possible that the sensor device 120, in the current position of the primary part 110 and in the presence of an offset sensor position, overlaps a plurality of boundaries 190 of adjacent pairs of permanent magnets or magnet groups 150, which may be detected on the basis of positive zero crossings of a magnetic field strength course of the third magnetic field component Bz reproduced by the current magnetic field data 250. Based on this, the evaluation for position determination with respect to one of the boundaries 190 may be carried out.

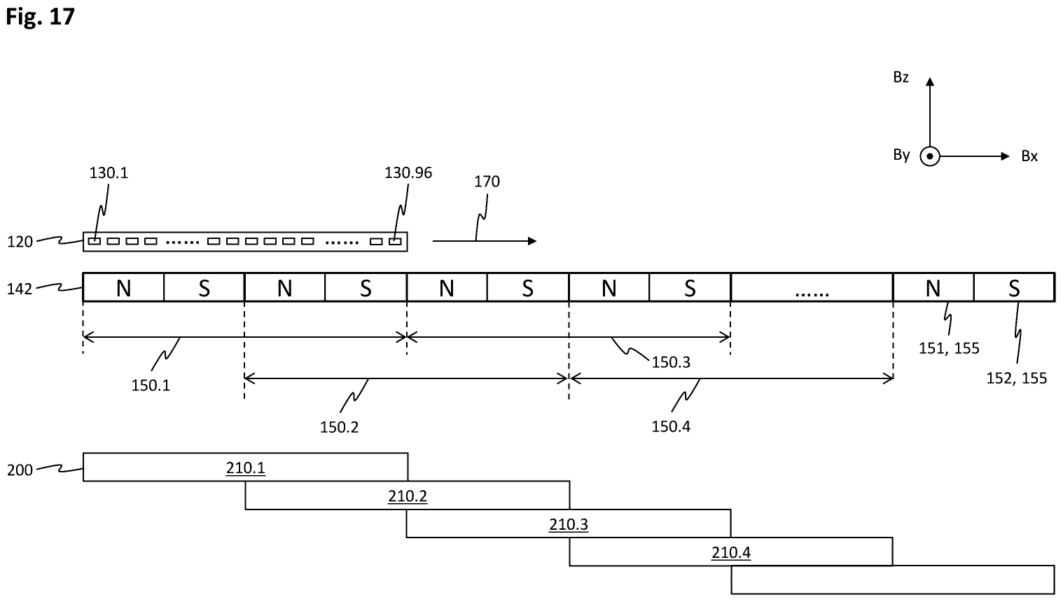

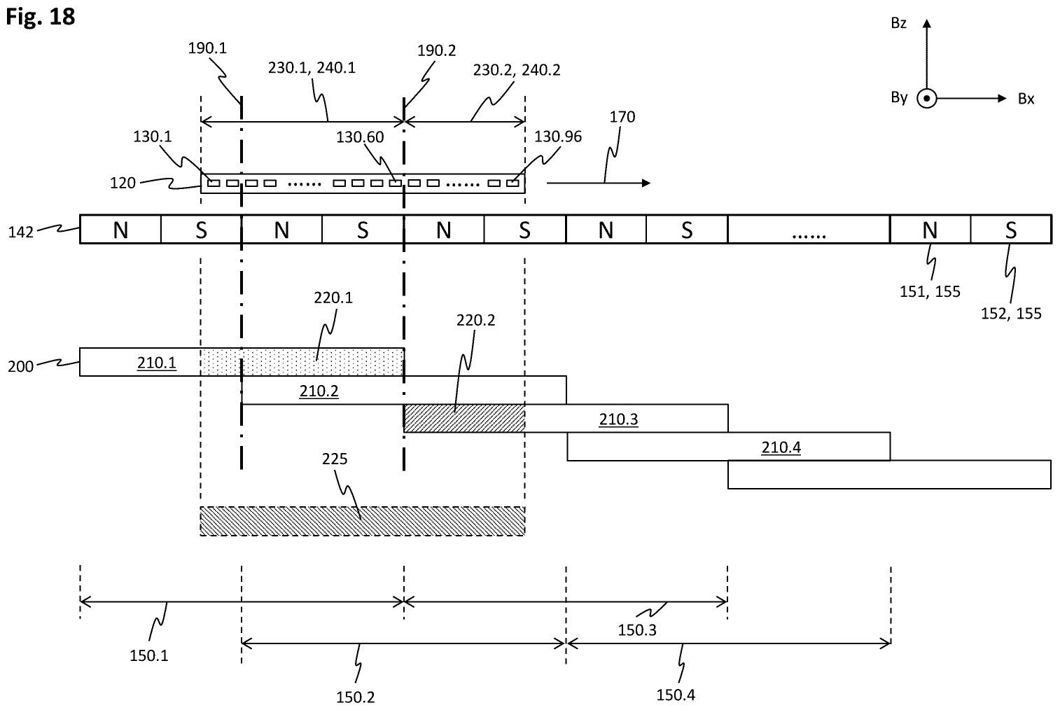

A possible example of this is described below with reference to FIGS. 17 and 18. Corresponding features and process steps as well as identical and equally acting components will not be described again in detail in the following. For details in this regard, reference is instead made to the above description, which may be applied in a corresponding manner.

FIG. 17 shows a further possible embodiment as may be considered for the sensor device 120 of the primary part 110. The sensor device 120 comprises ninety-six magnetic field sensors 130, i.e. from a first magnetic field sensor 130.1 to a ninety-sixth magnetic field sensor 130.96, which are distributed along the direction of movement 170 and are arranged spaced apart from one another. The sensor device 120 is configured such that a complete or substantially complete overlap of two pairs of permanent magnets, each comprising a first and a second permanent magnet 151, 152, may be achieved with the aid of the magnetic field sensors 130. Accordingly, for the purpose of position determination, such an allocation or division of the permanent magnets 155 of the magnet arrangement 142 of the secondary part 140 is provided, according to which the magnet groups 150 also comprise two permanent magnet pairs each composed of a first and second permanent magnet 151, 152, and thus a total of four permanent magnets 155.

The allocation of the pairs of permanent magnets to the magnet groups 150 is in the present case selected in such a way that the magnet groups 150 partially overlap. With reference to the depiction of FIG. 17 and from left to right, the first magnet group 150.1 therefore comprises a first and a second pair of permanent magnets, the second magnet group 150.2 comprises the second and a third pair of permanent magnets, the third magnet group 150.3 comprises the third and a fourth pair of permanent magnets, and so on. The further effect of this division is that adjacent magnet groups 150 in the evaluation carried out for the purpose of determining the position with the aid of the main controller 105 are each two adjacent magnet groups 150 or, in other words, the magnet groups 150 located on either side with respect to a boundary 190, and thus in each case two magnet groups 150 having either an odd index or an even index. For example, the first and third magnet groups 150.1, 150.3 represent two adjacent magnet groups 150. This is correspondingly true of the second and fourth magnet groups 150.2, 150.4.

With respect to FIG. 17, it is also noted that the first magnet group 150.1 may not be a magnet group 150 located at a (left) end of the magnet arrangement 142, and may be considered as the first magnet group 150.1 for the following description only. At least one further pair of permanent magnets may be located to the left of the first magnet group 150.1. Consequently, to the left of the second magnet group 150.2, there may be another magnet group 150 adjacent with respect to the second magnet group 150.2.

FIG. 17 further illustrates the magnetic field patterns 210 of the reference magnetic field data 200 assigned to the individual magnetic groups 150, which partially overlap corresponding to the magnetic groups 150. The magnetic field patterns 210 may also be obtained in this embodiment in the initial measurement analogous to the procedure described above. In this context, the primary part 110 may be moved along the secondary part 140, and the provision of the magnetic field patterns 210 may be carried out based on the magnetic field detected by the magnetic field sensors 130 of the sensor device 120 each time the magnetic field sensors 130 are located in the area of a magnetic group 150, and thereby an overlap of the respective magnetic group 150 by the magnetic field sensors 130 occurs. In this context, the provision of the magnetic field patterns 210 may be coordinated with positive zero crossings of a magnetic field strength course of the third magnetic field component Bz detected with the aid of an end-side magnetic field sensor 130, for example the first magnetic field sensor 130.1, during the movement of the primary part 110, over which boundaries 190 of adjacent permanent magnet pairs and magnet groups 150 may be reproduced (cf. FIG. 18).

According to the ninety-six magnetic field sensors 130 of the sensor device 120, the current magnetic field data 250 obtained by detecting the magnetic field of the magnet arrangement 142 of the secondary part 140 using the magnetic field sensors 130 at the current position of the primary part may have ninety-six data points per magnetic field component Bx, By, Bz. This also applies to the magnetic field patterns 210 provided as part of the initial measurement.

For determining the position of the primary part 110 on the secondary part 140, the steps and process variants described above may be applied in a corresponding manner. In the event that the magnetic field sensors 130 of the sensor device 120 in the current position of the primary part 110 are located in the area of a magnet group 150 of the magnet arrangement 142 of the secondary part 140, wherein the relevant magnet group 150 is overlapped by the magnetic field sensors 130 and a situation comparable to FIG. 17 may exist, such a positioning may be detected by determining the sensor position of the sensor device 120 with respect to a boundary 190 of two adjacent pairs of permanent magnets or magnet groups 150. The boundary 190 in question may be located in the region of an edge or end of the sensor device 120. Such a sensor position may be determined based on a presence of a positive zero crossing in a magnetic field strength course of the third magnetic field component Bz, which may be reflected by the current magnetic field data 250 obtained using all of the magnetic field sensors 130 at the current position.

If there is no positive zero crossing in the area of the ends of the magnetic field strength course, it may be detected that the magnetic field sensors 130 of the sensor device 120 are located in the area of a magnetic group 150 in the current position of the primary part 110 and that the magnetic group 150 in question is overlapped by the magnetic field sensors 130. In this case, to determine the position of the primary part 110, according to FIG. 7, the current magnetic field data 250 may be compared to the magnetic field patterns 210 of the reference magnetic field data 200 to determine a magnetic field pattern 210 with the greatest similarity, thus the associated magnetic group 150, and insofar the positioning of the sensor device 120 at the relevant magnetic group 150. Furthermore, the distance relative to the direction of movement 170 between a boundary 190 and a magnetic field sensor 130 closest to the boundary 190, for example the first magnetic field sensor 130.1, may additionally be determined. This may be done with the aid of an extrapolation using the magnetic field strength course of the third magnetic field component Bz reproduced by the current magnetic field data 250.

In the current position of the primary part 110, the sensor device 120 may also be at an offset in the area of two adjacent (adjoining) magnet groups 150, as illustrated in FIG. 18. Due to the overlapping magnet groups 150, the staggered arrangement of the sensor device 120 may thereby refer to two pairs of adjacent magnet groups 150. According to the illustration in FIG. 18, this applies to the first and to the third magnet group 150.1, 150.3 adjacent thereto. If, as indicated above, a further pair of permanent magnets is provided to the left of the first magnet group 150.1 and, insofar, a further magnet group 150 is provided to the left of and adjacent to the second magnet group 150.2, the staggered arrangement of the sensor device 120 is also present with respect to this further magnet group 150 and the second magnet group 150.2. Due to the staggered arrangement, the respective adjacent magnet groups 150 are each partially overlapped by the magnetic field sensors 130 of the sensor device 120.

Due to the fact that the sensor device 120 may overlap two pairs of permanent magnets in the present case (cf. FIG. 17), the sensor device 120 may furthermore be located over two boundaries 190 of adjacent pairs of permanent magnets or groups of magnets 150 in the case of staggered positioning, as illustrated in FIG. 18 with the aid of a first boundary 190.1 and a second boundary 190.2. The two boundaries 190.1, 190.2 may also be detected based on current magnetic field data 250 obtained at the current position of the primary part 110 using the magnetic field sensors 130. The boundaries 190.1, 190.2 coincide with positive zero crossings of the magnetic field strength course of the third magnetic field component Bz reproduced by the current magnetic field data 250, and may therefore be detected based on the zero crossings.

For the determination of the sensor position of the sensor device 120 with respect to a boundary 190 carried out within the framework of the position determination, as described above, one of the two boundaries 190 may be selected and used. For example, the second boundary 190.2 shown in FIG. 18 with reference to the direction of movement 170 on the right may be selected. Corresponding to this, further evaluation is also carried out using the selected boundary 190.

In determining the sensor position, in accordance with the above description, the distance relative to the direction of movement 170 between the selected boundary 190 and the magnetic field sensors 130 of the sensor device 120 located closest to and on either side of the boundary 190 may be determined. This may be carried out using the magnetic field strength course of the third magnetic field component Bz reflected by the current magnetic field data 250, by identifying the magnetic field sensors 130 located closest to the boundary 190, and carrying out an interpolation or extrapolation taking into account the distance between the magnetic field sensors 130 in question. For example, according to FIG. 18, a sixtieth magnetic field sensor 130.60 located to the left of the second boundary 190.2 is positioned closest to the second boundary 190.2.

Based on the determined sensor position of the sensor device 120 with respect to the selected boundary 190, the method variations described above for determining the current position of the primary part 110 may be carried out as follows.

If it is determined that the sensor device 120 is in the area of two adjacent (adjoining) magnetic groups 150 and both magnetic groups 150 are each partially overlapped by the sensor device 120, a partial data set 260 may be formed from the current magnetic field data 250 obtained using a sensor subgroup 240 of magnetic field sensors 130 of the sensor device 120 by which the partial overlap of one of the two magnetic groups 150 is realized. Correspondingly, partial overlap patterns 220 may be formed from the magnetic field patterns 210 of the reference magnetic field data 200, which replicate the partial overlap realized by the sensor subgroup 240 with respect to each magnetic group 150 and its magnetic field patterns 210. In the similarity comparison, the partial data set 260 may be compared to each of the partial patterns 220 to determine a partial pattern 220 and the corresponding magnetic field pattern 210 with the greatest similarity, and thereby the positioning of the sensor device 120 at the relevant magnet group 150. Together with the detected sensor position of the sensor device 120, this information provides the current position of the primary part 110.

As indicated above, the evaluation is carried out taking into account the selected boundary 190. The selection of the boundary 190 affects the determination of the sensor partial set 240, thus the formation of the partial set 260 from the current magnetic field data 250, and also the formation of the partial set 220 from the magnetic field patterns 210.

In FIG. 18, this procedure is illustrated with reference to the second boundary 190.2 as the selected boundary 190 separating two adjacent magnetic groups 150, i.e. in this case the first and third magnetic groups 150.1, 150.3. The larger partial overlap (with a first overlapping region 230.1) is thereby provided by a first sensor subgroup 240.1 comprising sixty magnetic field sensors 130 (with the first to the sixtieth magnetic field sensor 130.1, 130.60). This may be determined based on the determined sensor position. Accordingly, a partial data set 260 belonging to the first sensor subgroup 240.1 and formed from the current magnetic field data 250 may be formed with sixty data points per magnetic field component Bx, By, Bz.

FIG. 18 further shows a formation of first partial patterns 220.1 that replicate the partial overlap provided by the first sensor subgroup 240.1 with respect to each magnetic group 150 and its magnetic field pattern 210. Corresponding to the sixty magnetic field sensors 130 of the first sensor subgroup 240.1, and to the sensor position of the sensor device 120 with respect to the second boundary 190.2, the first partial patterns 220.1 comprise per magnetic field component Bx, By, Bz respectively the last sixty data points of the magnetic field patterns 210. In FIG. 18, a first partial pattern 220.1 is shown only at the first magnetic field pattern 210.1. In the similarity comparison, the partial data set 260 may be compared to the first partial patterns 220.1.

As an alternative, it is possible to carry out the formation of the partial data set 260, the partial patterns 220 and the comparison with respect to the other of the two partial overlaps, as shown in FIG. 18 with reference to a second sensor partial set 240.2 comprising thirty-six magnetic field sensors 130 (with a second overlapping region 230.2). The partial data set 260 formed here from the current magnetic field data 250 may comprise thirty-six data points per magnetic field component Bx, By, Bz in a corresponding manner. This also applies to second partial patterns 220.2 formed from the magnetic field patterns 210, which replicate the partial overlap effected by the second sensor subgroup 240.2 with respect to each magnetic group 150 and its magnetic field pattern 210. Corresponding to the thirty-six magnetic field sensors 130 of the second sensor subgroup 240.2, and to the sensor position of the sensor device 120 with respect to the second boundary 190.2, the second partial patterns 220.2 comprise the first thirty-six data points of the magnetic field patterns 210 for each magnetic field component Bx, By, Bz, respectively. In FIG. 18, a second partial pattern 220.2 is shown only at the third magnetic field pattern 210.3. In the similarity comparison, the partial data set 260 may be compared to the second partial patterns 220.2.

In the case of a determined sensor position of the sensor device 120 in the area of two adjacent (adjoining) magnet groups 150, it is further possible to form newly composed magnetic field patterns 225, which are each composed of partial patterns 220 from the magnetic field patterns 210 of two adjacent magnet groups 150 provided during the initial measurement, taking into account the partial overlaps. With the aid of the newly composed magnetic field patterns 225, the positioning of the sensor device 120 determined on the basis of the sensor position, and thus the overlap caused by the sensor device 120, may be replicated in each case with respect to two adjacent magnet groups 150 of the magnet arrangement 142. In the similarity comparison, the current magnetic field data 250 may be compared to the newly composed magnetic field patterns 225 to determine a composed magnetic field pattern 225 with the greatest similarity, and thereby the positioning of the sensor device 120 at the associated two magnet groups 150. Together with the detected sensor position of the sensor device 120, this information provides the current position of the primary part 110.

The aforementioned evaluation is also carried out, as indicated above, taking into account the selected boundary 190, with the selection of the boundary 190 affecting the formation of the newly assembled magnetic field patterns 225.

FIG. 18 illustrates the formation of newly composed magnetic field patterns 225 with respect to the second boundary 190.2 as a selected boundary 190 separating two adjacent magnetic groups 150 and first and third magnetic groups 150.1, 150.3, respectively, with the first magnetic group 150.1 being overlapped by the first sensor subgroup 240.1 and the third magnetic group 150.3 being overlapped by the second sensor subgroup 240.2. The composed magnetic field patterns 225 each comprise a first partial pattern 220.1 of a magnetic field pattern 210 of a magnet group 150 and a second partial pattern 220.2 of a magnetic field pattern 210 of a magnet group 150 adjacent thereto. Via a first partial pattern 220.1, the partial overlap effected by the first sensor subgroup 240.1 is reproduced in each case with respect to a magnet group 150, and via a second partial pattern 220.2, the partial overlap effected by the second sensor subgroup 240.2 is reproduced in each case with respect to a magnet group 150 adjacent thereto.

In FIG. 18, the formation of a composed partial pattern 225 is shown only with respect to the first and third magnetic field patterns 210.1, 210.3, which belong to two adjacent (adjoining) magnetic groups 150, i.e., the first and third magnetic groups 150.1, 150.3. In this regard, the illustrated composed magnetic field pattern 225 is formed using a first partial pattern 220.1 of the first magnetic field pattern 210.1 and a second partial pattern 220.2 of the third magnetic field pattern 210.3. Similarly, another composed magnetic field pattern 225 may be formed using a first partial pattern 220.1 of the second magnetic field pattern 210.2 and a second partial pattern 220.2 of the fourth magnetic field pattern 210.4. Forming further composed magnetic field patterns 225 may be continued in a similar manner until an nth magnetic field pattern 210 is formed.

Corresponding to the sixty magnetic field sensors 130 of the first sensor subgroup 240.1 and to the sensor position of the sensor device 120 with respect to the second boundary 190.2, the first partial patterns 220.1 per magnetic field component Bx, By, Bz each comprise the last sixty data points of the magnetic field patterns 210 used. Corresponding to the thirty-six magnetic field sensors 130 of the second sensor subgroup 240.2 and to the sensor position of the sensor device 120 with respect to the second boundary 190.2, the second partial patterns 220.2 each comprise, per magnetic field component Bx, By, Bz, the first thirty-six data points of the magnetic field patterns 210 used. The composed magnetic field patterns 225 thereby comprise, corresponding to the current magnetic field data 250, ninety-six data points per magnetic field component Bx, By, Bz.

It is further possible to carry out the evaluation on the basis of a predetermined division of the magnetic field sensors 130 of the sensor device 120 into a plurality of sensor subgroups 240, the division being independent of the sensor position of the sensor device 120 present in the current position of the primary part 110. According to the division, the current magnetic field data 250 may be divided into a plurality of partial data sets 260 obtained using the individual sensor subgroups 240 each partially overlapping the magnet arrangement 142. Corresponding to this, partial patterns 220 may be formed from the magnetic field patterns 210 of the reference magnetic field data 200, which is done by taking into account the detected sensor position of the sensor device 120 in the current position of the primary part 110 as well as by taking into account the division of the magnetic field sensors 130 and thus the partial overlaps caused by the sensor subgroups 240.

The partial patterns 220 may reflect the partial overlaps effected by each of the sensor subgroups 240, respectively, with respect to two adjacent (adjoining) magnet groups 150 of the magnet arrangement 142. In the similarity comparison, the partial data sets 260 may be compared to the respective associated partial patterns 220 with respect to the sensor position and the distribution of the magnetic field sensors 130 to determine the partial patterns 220 with the greatest similarity, and thereby the positioning of the sensor device 120 at the associated two adjacent magnet groups 150. Together with the detected sensor position of the sensor device 120, this information reflects the current position of the primary part 110.

With regard to the aforementioned evaluation, with reference to the sensor device 120 comprising ninety-six magnetic field sensors 130, for example, a division of the magnetic field sensors 130 analogous to FIG. 12 or FIG. 15 may be considered, i.e. a division into two sensor subgroups 240 or three partially overlapping sensor subgroups 240 with forty-eight magnetic field sensors 130 each. The evaluation is also carried out here taking into account the selected boundary 190, which has an effect in the present case on the formation of the partial patterns 220. The formation of the partial patterns 220 from the magnetic field patterns 210 is carried out in each case with reference to two adjacent (adjoining) magnetic groups 150, so that with the aid of the partial patterns 220 the partial overlaps brought about by the sensor subgroups 240 are reproduced in each case with reference to two adjacent magnetic groups 150.

With reference to FIG. 17, as indicated above, these are each two magnet groups 150 with either an even index or an odd index. In the event that a sensor subgroup 240 overlaps the selected boundary 190, which may be detected on the basis of the detected sensor position, those partial patterns 220 which reproduce the partial overlap caused by this sensor subgroup 240 may be formed analogously to the procedure described with reference to FIG. 12 or FIG. 15 by combining corresponding parts of magnetic field patterns 210 of adjacent (adjoining) magnet groups 150.

The current position of the primary part 110 with respect to the secondary part 140 determined in accordance with the method may be an immobile position, as indicated above, such that there is no movement generation at the linear drive system 100. From this, the primary part 110 and the secondary part 140 may be moved relative to each other in the further operation of the linear drive system 100 controlled by the main controller 105.

In this context, the current position determined according to the method and with the aid of the main controller 105 may serve as a reference position to which subsequently carried out movements and thereby position changes of the primary part 110 with respect to the secondary part 140 may be referred back. In this context, the changes in position may be determined on the basis of the magnetic field of the magnet arrangement 142 of the secondary part 140 detected with the aid of one or a plurality of magnetic field sensors 130 of the sensor device 120. The detection of the movement, which may be carried out as part of a corresponding evaluation by the main controller 105, may be carried out in an incremental manner, for example, by determining the associated position changes with respect to individual permanent magnet pairs or magnet groups 150 of the magnet arrangement 142. Based thereon, incrementing of a corresponding counter may be carried out.

Furthermore, with reference to the linear drive system 100, an embodiment different from the above description may be considered in which the primary part 110 is a stationary component and the secondary part 140 is a movable component of the drive system 100. In this embodiment, the secondary part 140 may be moved relative to the primary part 110 due to the magnetic interaction between the electromagnet device 111 of the primary part 110 and the magnet arrangement 142 of the secondary part 140. Further, the secondary part 140 may be arranged, for example, differently from FIG. 1, above the primary part 110. Suitable components may be used to guide or support the movable secondary part 140 on or relative to the stationary primary part 110.

With respect to such an embodiment of the linear drive system 100, the above-described method and its method variants may be carried out in a corresponding manner to determine the current position of the primary part 110 with respect to the secondary part 140. This position is equivalent to a positioning of the secondary part 140 with respect to the primary part 110.

In this context, the initial measurement may comprise moving the secondary part 140 relative to the primary part 110 and, analogously to the foregoing description, providing the magnetic field patterns 210 of the reference magnetic field data 200 based on the magnetic field of the magnet arrangement 142 of the secondary part 140, which is detected with the aid of the sensor device 120 of the primary part 110 in each case when the magnetic field sensors 130 of the sensor device 120 are located in the area of a magnet group 150 and overlap the relevant magnet group 150. In order to determine an unknown current position of the primary part 110 with respect to the secondary part 140 (and thereby a current positioning of the secondary part 140 relative to the primary part 110), current magnetic field data 250 may be obtained at the current position by sensing the magnetic field of the magnet arrangement 142 of the secondary part 140 using the sensor device 120 of the primary part 110. By carrying out an evaluation using the current magnetic field data 250 and the reference magnetic field data 200 as described above, the sought current position of the primary part 110 relative to the secondary part 140 (and thus the positioning of the secondary part 140 relative to the primary part 110) may be determined.

Although the invention has been further illustrated and described in detail by embodiments, the invention is not limited by the disclosed examples and other variations may be derived therefrom by those skilled in the art without departing from the protective scope of the invention.

TABLE 1
List of reference symbols

| | |
|---|---|
| 100 | linear drive system |
| 105 | main controller |
| 107 | connecting cable |
| 110 | primary part |
| 111 | electromagnet device |
| 112 | housing |
| 113 | connector |
| 120 | sensor device |
| 121 | circuit board |
| 130 | magnetic field sensor |
| 140 | secondary part |
| 141 | carrier plate |
| 142 | magnet arrangement |
| 150 | magnet group |
| 151 | permanent magnet |
| 152 | permanent magnet |
| 155 | permanent magnet |
| 161 | course of magnetic field strength |
| 162 | course of magnetic field strength |
| 163 | course of magnetic field strength |
| 170 | direction of movement |
| 180 | zero crossing |
| 185 | vertex |
| 190 | boundary |
| 200 | reference magnetic field data |
| 205 | magnetic field data |
| 210 | magnetic field pattern |
| 220 | partial pattern |
| 225 | composed magnetic field pattern |
| 230 | overlapping region |
| 240 | sensor subgroup |
| 250 | current magnetic field data |
| 260 | partial data set |
| 263 | course of magnetic field strength |
| 270 | distance measure |
| 281 | evaluation |
| 282 | evaluation |
| 283 | evaluation |
| B | flux density |
| Bx | magnetic field component |
| By | magnetic field component |
| Bz | magnetic field component |
| M | number magnetic field sensor |
| P | position |

1. A method for operating a linear drive system, wherein:
the linear drive system comprises a primary part and a secondary part, which may be moved in a translatory manner relative to each other,
wherein the primary part comprises an electromagnet device which may be energized, and the secondary part comprises a magnet arrangement of permanent magnets arranged next to each other,
wherein by energizing the electromagnet device of the primary part a magnetic interaction between the electromagnet device and the magnet arrangement of the secondary part may be caused to move the primary part and the secondary part relative to each other, and
wherein the primary part comprises a sensor device of magnetic field sensors for detecting a magnetic field generated by the magnet arrangement of the secondary part;
wherein, in an initial measurement, the magnetic field of the magnet arrangement of the secondary part is detected with the aid of the sensor device at different positions of the primary part with respect to the secondary part and position-dependent reference magnetic field data are provided, and
wherein a position determination for the primary part is carried out, in that:
the magnetic field of the magnet arrangement of the secondary part is detected with the aid of the sensor device at a current position of the primary part with respect to the secondary part and current magnetic field data are provided, and
based on the reference magnetic field data and the current magnetic field data, the current position of the primary part with respect to the secondary part is determined.

2. The method according to claim 1, wherein the position determination comprises carrying out a comparison of at least a part of the current magnetic field data with parts of the reference magnetic field data using a similarity method.

3. The method according to claim 2, wherein the similarity method is a dynamic time warping (DTW) method.

4. The method according to claim 2, wherein the position determination is based on dividing up the permanent magnets of the magnet arrangement of the secondary part into a plurality of magnet groups of permanent magnets arranged next to each other, and the reference magnetic field data comprises a plurality of magnetic field patterns, each of which being associated with a magnet group of permanent magnets arranged next to each other of the magnet arrangement of the secondary part.

5. The method according to claim 4, wherein carrying out the comparison comprises at least one of the following:
comparing the current magnetic field data to the magnetic field patterns;
comparing at least a partial data set of the current magnetic field data to at least a partial pattern of the magnetic field patterns;
comparing the current magnetic field data to newly composed magnetic field patterns formed from partial patterns of the magnetic field patterns; and/or
comparing a plurality of partial data sets of the current magnetic field data to partial patterns of the magnetic field patterns.

6. The method according to claim 4, wherein in terms of dimensions, the sensor device of the primary part is embodied in such a way that an overlap of a magnet group, with reference to a direction of movement of the primary part and secondary part, may be achieved with the aid of the magnetic field sensors.

7. The method according to claim 4, wherein in the initial measurement, the primary part and the secondary part are moved relative to each other and the magnetic field patterns are provided based on the detected magnetic field of the magnet arrangement of the secondary part, which is detected with the aid of the sensor device when the magnetic field sensors of the sensor device are each located in the area of a magnet group.

8. The method according to claim 7, wherein a determination that the magnetic field sensors of the sensor device are each located in the area of a magnet group is carried out on the basis of zero crossings of a course of a magnetic field component of the magnetic field of the magnet arrangement of the secondary part, which is detected with the aid of an end-side magnetic field sensor of the sensor device.

9. The method according to claim 4, wherein:
the position determination comprises determining a sensor position of the sensor device with respect to a boundary of two adjacent magnet groups or of two adjacent pairs of permanent magnets in the current position of the primary part, and
wherein carrying out the comparison is performed taking into account the determined sensor position of the sensor device.

10. The method according to claim 9, wherein determining the sensor position of the sensor device is carried out on the basis of a zero crossing of a course of a magnetic field component of the magnetic field of the magnet arrangement of the secondary part, which is reproduced by the current magnetic field data.

11. The method according to claim 9, wherein:
in case of a sensor position of the sensor device in the area of two adjacent magnet groups, so that both magnet groups are each partially overlapped by the sensor device, a partial data set is formed from the current magnetic field data, which was obtained with the aid of a sensor subgroup of magnetic field sensors of the sensor device, by which the partial overlap of one of the two magnet groups is produced,
wherein partial patterns are formed from the magnetic field patterns taking into account the partial overlap, and
wherein for carrying out the comparison, the partial data set of the current magnetic field data is compared to the partial patterns of the magnetic field patterns.

12. The method according to claim 9, wherein:
in case of a sensor position of the sensor device in the area of two adjacent magnet groups, so that both magnet groups are each partially overlapped by the sensor device, composed magnetic field patterns are formed, which are composed of partial patterns of magnetic field patterns of two adjacent magnet groups, in each case taking into account the partial overlaps, and
wherein for carrying out the comparison, the current magnetic field data are compared to the composed magnetic field patterns.

13. The method according to claim 9, wherein:
the current magnetic field data are divided up into partial data sets, each of which was obtained with the aid of a sensor subgroup of magnetic field sensors of the sensor device partially overlapping the magnet arrangement,
wherein partial patterns are formed from the magnetic field patterns taking into account the sensor position of the sensor device and taking into account the partial overlaps by the sensor subgroups, and
wherein for carrying out the comparison, the partial data sets are compared to the partial patterns.

14. A linear drive system, wherein:
the linear drive system comprises a primary part and a secondary part which may be moved in a translatory manner relative to each other,
wherein the primary part comprises a energizable electromagnet device and the secondary part comprises a magnet arrangement of permanent magnets arranged next to each other,
wherein by energizing the electromagnet device of the primary part, a magnetic interaction between the electromagnet device and the magnet arrangement of the secondary part may be caused to move the primary part and the secondary part relative to each other, and
wherein the primary part comprises a sensor device of magnetic field sensors for detecting a magnetic field generated by the magnet arrangement of the secondary part;
wherein the linear drive system is embodied, in an initial measurement, to detect the magnetic field of the magnet arrangement of the secondary part with the aid of the sensor device at different positions of the primary part with respect to the secondary part and to provide position-dependent reference magnetic field data,
wherein the linear drive system is embodied to carry out a position determination for the primary part, in that:
the magnetic field of the magnet arrangement of the secondary part is detected with the aid of the sensor device at a current position of the primary part with respect to the secondary part and current magnetic field data are provided, and
based on the reference magnetic field data and the current magnetic field data, the current position of the primary part with respect to the secondary part is determined.

15. A method for operating a linear drive system, wherein:
the linear drive system comprises a primary part and a secondary part, which may be moved in a translatory manner relative to each other,
wherein the primary part comprises an electromagnet device which may be energized, and the secondary part comprises a magnet arrangement of permanent magnets arranged next to each other,
wherein by energizing the electromagnet device of the primary part a magnetic interaction between the electromagnet device and the magnet arrangement of the secondary part may be caused to move the primary part and the secondary part relative to each other, and
wherein the primary part comprises a sensor device of magnetic field sensors for detecting a magnetic field generated by the magnet arrangement of the secondary part;
wherein, in an initial measurement, the magnetic field of the magnet arrangement of the secondary part is detected with the aid of the sensor device at different positions of the primary part with respect to the secondary part and position-dependent reference magnetic field data are provided,
wherein a position determination for the primary part is carried out, in that:
the magnetic field of the magnet arrangement of the secondary part is detected with the aid of the sensor device at a current position of the primary part with respect to the secondary part and current magnetic field data are provided, and
based on the reference magnetic field data and the current magnetic field data, the current position of the primary part with respect to the secondary part is determined;
wherein the position determination comprises carrying out a comparison of at least a part of the current magnetic field data with parts of the reference magnetic field data, and
wherein the position determination is based on dividing up the permanent magnets of the magnet arrangement of the secondary part into a plurality of magnet groups of permanent magnets arranged next to each other, and the reference magnetic field data comprises a plurality of magnetic field patterns, each of which being associated with a magnet group of permanent magnets arranged next to each other of the magnet arrangement of the secondary part.

16. The method according to claim 15, wherein the comparison of at least a part of the current magnetic field data with parts of the reference magnetic field data is carried out using a similarity method.

17. The method according to claim 15, wherein the comparison of at least a part of the current magnetic field data with parts of the reference magnetic field data is carried out using a dynamic time warping (DTW) method.
